(19) United States
(12) Patent Application Publication
(10) Pub. No.: US 2023/0021315 A1
(43) Pub. Date: Jan. 26, 2023

(54) SYSTEMS AND METHODS FOR DEFECT DETECTION

(71) Applicant: SMARTE EUROPE, UNIPESSOAL LDA, Porto (PT)

(72) Inventors: Gilberto MARTINS LOUREIRO, Porto (PT); Antonio ROCHA, Porto (PT); Paulo RIBEIRO, Porto (PT)

(21) Appl. No.: 17/817,569

(22) Filed: Aug. 4, 2022

Related U.S. Application Data
(63) Continuation of application No. PCT/IB2021/050858, filed on Feb. 3, 2021.
Application No. PCT/IB2021/050858 is a continuation of application No. PCT/PT2020/050012, filed on Mar. 25, 2020.
Application No. PCT/PT2020/050012 is a continuation of application No. PCT/PT2020/050003, filed on Feb. 5, 2020.

(51) Int. Cl. G01N 21/89; G01N 21/898; G06T 7/00

(52) U.S. Cl. CPC G01N 21/8901; G01N 21/8914; G01N 21/8983; G06T 7/0008; G01N 2021/8918; G01N 2021/8917; G06T 2207/30124; G06T 2207/30136

(57) ABSTRACT

Systems and methods are disclosed for detecting defects during manufacturing processes for materials and products. The provided systems may utilize imaging units and computer detection algorithms to determine the presence or absence of defects in manufactured materials or products. Detection of defects in material or products by the disclosed systems may prompt intervention in the manufacturing process to correct the source of the defects.

### CROSS-REFERENCE

This application is a continuation of International Application No. PCT/IB2021/050858 filed on Feb. 3, 2021, which claims priority to International Application No. PCT/PT2020/050003 filed on Feb. 5, 2020, and International Application No. PCT/PT2020/050012 filed on Mar. 25, 2020, each of which is incorporated herein by reference in its entirety for all purposes.

### BACKGROUND

Some materials and products may be produced by high-volume manufacturing processes. Such materials and products may include textiles such as natural or synthetic fabrics, structural materials such as sheet metals, piping, and wood products, paper products and other materials such as ceramics, composites, and plastics.

Manufactured products may be produced via specialized machinery that produce such products on a continuous or batch-wise basis. For example, textiles may be produced on knitting machines that extrude a continuous sheet of knitted fabric. Manufactured products may be produced in a range of dimensions including varying lengths, widths, or thicknesses. Manufacturing equipment and machinery may include process sensing and control equipment.

### SUMMARY

Recognized herein is a need for detection systems that can actively monitor the output from manufacturing equipment. Such detection systems may be capable of detecting subtle or obvious manufacturing defects that may escape human detection. In some cases, defects in a manufactured product, such as needle defects in a textile product, may not be readily apparent to the human eye. In other cases, products may be released from a manufacturing process and moved to subsequent processes at a rate that exceeds the human ability to recognize and remove defective products from the product stream. Optical detection systems may offer defect detection capabilities over a much broader range of length scales and at much higher rates of manufacturing processivity than humans can operate. Manufacturing systems can be readily modified to include optical detection systems that are coupled to computer systems for defect detection. In some cases, such detection systems may be capable of isolating defective products from a product stream. In other cases, such detection systems may be capable of recognizing defects arising from malfunctioning manufacturing equipment, thereby allowing stoppage of the defective equipment. Optical detection systems for manufacturing equipment can permit reduced loss from the production of unsellable product, as well as reduced danger from the export of potentially unsound structural materials.

The present disclosure provides optical detection systems and methods for using these systems to monitor the output of a manufacturing process. The optical detection systems may be applied to a variety of material and product manufacturing processes including textile production, as well as metal, paper, ceramic, polymer and composite materials and/or products. In some cases, the optical detection systems comprise an imaging unit having a detection device and optionally a light source. The imaging unit may be connected by a data transmission link to a computer system where analysis of data from the imaging unit is performed. In some cases, the optical detection system is calibrated to a target region of the manufactured material or product to improve the reliability and accuracy of data collection during a manufacturing process.

In an aspect, the present disclosure provides a system comprising an imaging unit configured for use with a material fabrication machine useable to produce a material sheet. The imaging unit is calibrated to a target region of the material sheet, and the imaging unit is configured to (i) capture an image or video corresponding to the target region as the material sheet is produced by the material fabrication machine and (ii) generate data corresponding to the image or video. The system also comprises an image analysis unit in communication with the imaging unit, where the image analysis unit comprises one or more computer processors that are individually or collectively configured to process the data to control quality or detect a presence of one or more defects on the material sheet substantially in real-time as the material sheet is being produced by the material fabrication machine.

In some embodiments, the material sheet is a textile. In some embodiments, the material sheet is a metal or metal alloy. In some embodiments, the material sheet is paper. In some embodiments, the material sheet is a plastic.

In some embodiments, the imaging unit is configured to capture the image or video corresponding to the target region prior to the material sheet being manipulated or converted into a roll form.

In some embodiments, the system further comprises the material fabrication machine. In some embodiments, the material fabrication machine comprises a circular knitting machine or a weaving machine.

In some embodiments, the system further comprises a support structure configured to support at least one of (i) the imaging unit and (ii) the illumination unit. In some embodiments, the support structure is configured to releasably mount to the material fabrication machine. In some embodiments, the support structure is provided as a stand-alone structure that is decoupled from the material fabrication machine. In some embodiments, the support structure is configured to be coupled to a movable portion of the material fabrication machine. In some embodiments, the movable portion comprises a rotative shaft or a rotative frame. In some embodiments, the support structure is configured to be coupled to a fixed stationary portion of the material fabrication machine.

In some embodiments, the system further comprises an illumination unit configured to transmit and direct light onto the target region. The light is useable to illuminate a plurality of portions of the material sheet as the plurality of portions passes through the target region during production of the material sheet. In some embodiments, the light is selected from the group consisting of visible light, infrared light, and ultraviolet light. In some embodiments, the light comprises one or more beams having one or more wavelengths from about 700 nanometers to about 1200 nanometers. In some embodiments, the light comprises one or more beams having one or more wavelengths from about 10 nanometers to about 400 nanometers. In some embodiments, the light comprises a plurality of wavelengths from about 10 nanometers to about 1200 nanometers. In some embodiments, the illumination unit is configured to direct the light at one or more angles relative to a plane defined by the target region. In some embodiments, the one or more angles ranges from about 1 degree to about 90 degrees. In some embodiments, at least one of the one or more angles is less than about 1 degree. In some embodiments, at least one of the one or more angles is greater than about 90 degrees.

In some embodiments, the system further comprises the material fabrication machine which comprises at least one rotatable portion that is configured to rotate as the material sheet is produced. In some embodiments, the at least one rotatable portion comprises a rotative shaft or a rotative frame. In some embodiments, at least one of (i) the illumination unit and (ii) the imaging unit is configured to be mounted to the rotative shaft or the rotative frame. In some embodiments, at least one of (i) the illumination unit and (ii) the imaging unit is configured to remain stationary as the at least one rotatable portion is rotating. In some embodiments, the illumination unit and the imaging unit are configured to remain stationary as the at least one rotatable portion is rotating to produce the material sheet. In some embodiments, at least one of (i) the illumination unit and (ii) the imaging unit is configured to move relative to the at least one rotatable portion as the at least one rotatable portion is rotating. In some embodiments, the illumination unit and the imaging unit are configured to move relative to the at least one rotatable portion as the at least one rotatable portion is rotating. In some embodiments, at least one of (i) the illumination unit and (ii) the imaging unit is configured to move at substantially a same speed or in a same direction as the at least one rotatable portion. In some embodiments, at least one of (i) the illumination unit and (ii) the imaging unit is configured to move at a different speed or in a different direction than the at least one rotatable portion. In some embodiments, the illumination unit and the imaging unit are located on a same side relative to a surface of the material sheet.

In some embodiments, the illumination unit is configured to be used for front-side illumination and the imaging unit is configured to be used for front-side imaging of the target region. In some embodiments, the illumination unit is configured to be used for back-side illumination and the imaging unit is configured to be used for back-side imaging of the target region.

In some embodiments, the illumination unit and the imaging unit are located on opposite sides relative to a surface of the material sheet, such that the material sheet is located between the illumination unit and the imaging unit. In some embodiments, the illumination unit is configured to be used for back-side illumination and the imaging unit is configured to be used for front-side imaging of the target region. In some embodiments, the illumination unit is configured to be used for front-side illumination and the imaging unit is configured to be used for back-side imaging of the target region.

In some embodiments, the imaging unit is configured to be mounted directly to the material fabrication machine.

In some embodiments, the imaging unit comprises one or more cameras. In some embodiments, the one or more cameras have an imaging resolution of at least about 0.1 millimeter. In some embodiments, the one or more cameras have an imaging resolution of less than about 0.1 millimeter. In some embodiments, the image analysis unit is further configured to determine a type, shape, or size of the one or more defects.

In some embodiments, the system further comprises a controller in communication with the material fabrication machine, where the controller is configured to generate a set of instructions for stopping or pausing operation of the material fabrication machine when the image analysis unit detects the presence of the one or more defects on the material sheet.

In some embodiments, the material sheet is a roll-to-roll produced material sheet. In some embodiments, the material sheet comprises a net, a web, or a film. In some embodiments, the material sheet comprises a composite comprising of two or more different material types.

In some embodiments, the material sheet has a thickness of at least about 5 micrometers. In some embodiments, the material sheet has a thickness of less than about 10 millimeters. In some embodiments, the material sheet is porous. In some embodiments, the material sheet is non-porous. In some embodiments, the material sheet is opaque. In some embodiments, the material sheet is transparent or translucent.

Also provided herein is a method comprising: (a) providing an imaging unit for use with a material fabrication machine that is useable to produce a material sheet, (b) calibrating the imaging unit to a target region of the material sheet, (c) using the imaging unit to (i) capture an image or video corresponding to the target region as the material sheet is produced by the material fabrication machine and (ii) generate data corresponding to the image or video, and (d) computer processing the data to control quality or detect a presence of one or more defects on the material sheet substantially in real-time as the material sheet is being produced by the material fabrication machine.

In some embodiments of the method, the calibrating in (b) comprises providing the imaging unit in a predetermined spatial configuration relative to the material sheet or the material fabrication machine. In some embodiments of the method, the computer processing in (d) comprises applying one or more image analysis algorithms to the data. In some embodiments, the one or more image analysis algorithms comprises a machine learning algorithm.

In some embodiments, the method further comprises using the computer processed data to generate a set of instructions for stopping or pausing operation of the material fabrication machine when the image analysis unit detects the presence of the one or more defects on the material sheet. In some embodiments, the method further comprises stopping or pausing the operation of the material fabrication machine in response to the set of instructions. In some embodiments, the method further comprises using the computer processed data to generate a set of corrective actions for addressing the one or more defects when the image analysis unit detects the presence of the one or more defects on the material sheet.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, where only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 depicts a schematic view of an imaging unit with a low angle configuration relative to a sheet of material, in accordance with some embodiments.

FIG. 2 depicts a schematic view of an imaging unit with an orthogonal configuration relative to a sheet of material, in accordance with some embodiments.

FIG. 3 depicts a schematic view of a target region on a sheet of material relative to the field of vision of a camera, in accordance with some embodiments.

FIG. 4 shows a schematic diagram of a computer system, in accordance with some embodiments.

FIG. 5 displays a block diagram of an optical detection method, in accordance with some embodiments.

FIG. 6 depicts a schematic view of an imaging unit adjustably mounted to a circular knitting machine, in accordance with some embodiments.

FIG. 7 displays a block diagram of an optical detection method, in accordance with some embodiments.

FIG. 8A depicts a first schematic view of an imaging unit for a roll-to-roll circular knitting machine, in accordance with some embodiments.

FIG. 8B depicts a second schematic view of an imaging unit for a roll-to-roll circular knitting machine, in accordance with some embodiments.

FIG. 8C depicts a third schematic view of an imaging unit for a roll-to-roll circular knitting machine, in accordance with some embodiments.

FIG. 8D depicts a fourth schematic view of an imaging unit for a roll-to-roll circular knitting machine, in accordance with some embodiments.

FIG. 9A shows a first configuration for an imaging unit for a roll-to-roll circular knitting machine, in accordance with some embodiments.

FIG. 9B shows a second configuration for an imaging unit for a roll-to-roll circular knitting machine, in accordance with some embodiments.

FIG. 9C shows a third configuration for an imaging unit for a roll-to-roll circular knitting machine, in accordance with some embodiments.

FIG. 9D shows a fourth configuration for an imaging unit for a roll-to-roll circular knitting machine, in accordance with some embodiments.

FIG. 9E shows a fifth configuration for an imaging unit for a roll-to-roll circular knitting machine, in accordance with some embodiments.

FIG. 10A shows a first configuration for an imaging unit for a circular knitting machine, in accordance with some embodiments.

FIG. 10B shows a second configuration for an imaging unit for a circular knitting machine, in accordance with some embodiments.

FIG. 10C shows a third configuration for an imaging unit for a circular knitting machine, in accordance with some embodiments.

FIG. 11A shows a first configuration for an adjustable mounting assembly with horizontal adjustments for an imaging unit, in accordance with some embodiments.

FIG. 11B shows a second configuration for an adjustable mounting assembly with vertical adjustments for an imaging unit, in accordance with some embodiments.

FIG. 11C shows a third configuration for an adjustable mounting assembly with vertical adjustments for an imaging unit, in accordance with some embodiments.

FIG. 12 shows mounting hardware for adding adjustable components to a mounting assembly of an imaging unit, in accordance with some embodiments.

FIG. 13 depicts theoretical fields of vision for various numbers of cameras in an imaging unit, in accordance with some embodiments.

FIG. 14 depicts configurations for multi-camera imaging units depending upon fabric width, in accordance with some embodiments.

FIG. 15 displays the image of an installed optical detection system on a circular knitting machine, in accordance with some embodiments.

FIG. 16A shows an illustration of a multi-camera imaging unit for a circular knitting machine, in accordance with some embodiments.

FIG. 16B displays two-dimensional (2D) defect data collected by an optical detection system from fabric produced by a circular knitting machine, in accordance with some embodiments.

FIG. 17 shows 2D defect data collected by an optical detection system from fabric produced by a circular knitting machine, in accordance with some embodiments.

FIG. 18 shows 2D needle defect data collected by an optical detection system from fabric produced by a circular knitting machine, in accordance with some embodiments.

FIG. 19 shows 2D lycra defect data collected by an optical detection system from fabric produced by a circular knitting machine, in accordance with some embodiments.

FIG. 20 displays an image of a circular knitting machine with an installed optical detection system that features a display terminal for user interface, in accordance with some embodiments.

FIG. 21 displays a schematic of a system comprising multiple computer systems linked to an imaging unit, in accordance with some embodiments.

FIG. 22 illustrates an example of a feedback loop that can be implemented to enhance defect detection and quality control of manufacturing processes, in accordance with some embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used herein, the term “material” generally refers to a product of a manufacturing process that may be subsequently utilized in one or more other manufacturing processes. For example, a knitting machine may produce a fabric material, which may be subsequently used to produce garments or other textile products. In another example, a metallurgical process may produce an untreated sheet metal material that may be subsequently used to cut parts or be formed into piping products.

As used herein, the term “product” generally refers to a composition produced from one or more manufactured materials by subsequent processing of the manufactured materials. For example, a knitted fabric material may be dyed, cut and sewn to produce a final garment product. A product may be an intermediate product or a final product.

As used herein, the term “defect” generally refers to an abnormality on the surface or within the volume of a material or product. Defects may include non-uniformities, non-conformities, misalignments, flaws, damages, aberrations, and irregularities in the material or product. As used herein, the term “regular defect” generally refers to a defect that repeats with a known pattern such as temporal recurrence, spatial recurrence, or repeating or similar morphology (e.g., holes of the same shape or size). As used herein, an “irregular defect” generally refers to a defect with a non-patterned recurrence such as temporal randomness, spatial randomness, or differing or dissimilar morphology (e.g., holes of random shapes or sizes).

As used herein, the term “quality” generally refers to a desired, predetermined, qualitative or quantitative property (or properties) of a material or product. A quality may encompass a plurality of properties that collectively form a standard for a material. For example, a quality of a textile may refer to a weight, color, thread count, thickness of the textile, fabric uniformity, smoothness, yarn uniformity, yarn thickness, absence of contaminations, or a combination thereof. As used herein, the term “substandard quality” generally refers to a material or product that fails to meet at least one quality control standard or benchmark for a desired property. In some cases, a substandard material or product may fail to meet more than one quality control standard or benchmark.

As used herein, the term “quality control” generally refers to a method of comparing a manufactured material or product to an established quality control standard or benchmark. A quality control method may comprise measuring one or more observable properties or parameters (e.g., length, width, depth, thickness, diameter, circumference, shape, color, density, weight, strength, etc.) of a manufactured material or product. Quality control may comprise comparison of one or more parameters of a material or product to a known benchmark or monitoring of variance of one or more parameters during a manufacturing process. Quality control may be qualitative (e.g., pass/fail) or quantitative (e.g., statistical analysis of measured parameters). A manufacturing process may be considered to meet a quality control standard if the variance of at least one material or product parameter is within about ±1%, ±2%, ±3%, ±4%, ±5%, ±6%, ±7%, ±8%, ±9%, or about ±10% of a quality control standard or benchmark.

As used herein, the term “calibrate,” “calibrating,” or “calibration” generally refers to calibrating one or more imaging units to one or more target regions of a material sheet. The calibrating may include providing the imaging unit(s) in a predetermined spatial configuration relative to a material fabrication machine that is useable to form the material sheet. The calibrating may also include providing the one or more imaging units in a predetermined spatial configuration for imaging the one or more target regions, such that the imaging unit(s) are in focus on the target region(s), and with the target region(s) lying within a field of view of the imaging unit(s). As used herein, the term “target region(s)” may generally refer to one or more regions that are defined on a material sheet. The target region(s) may be of any predetermined shape, size or dimension.

The term “real-time,” as used herein, generally refers to a simultaneous or substantially simultaneous occurrence of a first event or action with respect to occurrence of a second event or action. A real-time action or event may be performed within a response time of less than one or more of the following: ten seconds, five seconds, one second, tenth of a second, hundredth of a second, a millisecond, or less relative to at least another event or action. A real-time action may be performed by one or more computer processors.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The terms “a,” “an,” and “the,” as used herein, generally refers to singular and plural references unless the context clearly dictates otherwise.

The present disclosure provides optical detection systems for performing quality control or identifying defects in products during manufacturing processes. In some cases, the described optical detection systems may be applied to quality control or defect detection in a range of manufacturing products including consumable products such as textiles, sheet metals, plastics, composites, ceramics, and paper products. Optical detection systems may be utilized for quality control or defect detection in manufacturing processes that operate continuously (e.g., fabric production from a knitting machine) or in a batch-wise fashion (e.g., extrusion of refractory tiles). The optical detection system may be coupled to process control systems, thereby permitting the removal of defective or substandard products or the stoppage of malfunctioning manufacturing equipment.

Optical detection systems may permit the detection of manufacturing defects or substandard materials or products over a broad range of length scales. In some cases, the described optical detection systems may be capable of detecting defects or substandard materials or products that are not readily apparent to the human eye, thereby permitting removal of defective products or substandard materials or products from a product stream. The described optical detection systems may also be capable of recognizing defects or substandard materials or products in materials produced at very high throughput rates where product processivity exceeds the ability of humans to recognize and remove defective products. Furthermore, implementing automated quality control or defect detection may permit enhanced process control in the absence of available quality assurance personnel, for example during night shifts.

The present disclosure provides optical detection system that may be coupled with manufacturing equipment to permit quality control or defect detection in products. The optical detection systems are intended to adapt to existing manufacturing equipment rather than necessitate the redesign of existing system to accommodate the new detection systems. Broadly speaking, the optical detection systems may include one or more sensor systems coupled to a computer system capable of implementing a quality control or defect detection algorithm. In some cases, an optical sensor may include a camera device. Optionally, the optical detection system may further include one or more light sources for illuminating the manufactured materials. The sensor system may transmit collected data to a computer system by a wireless data connection, a wired data connection, or a combination of wired/wireless data connections.

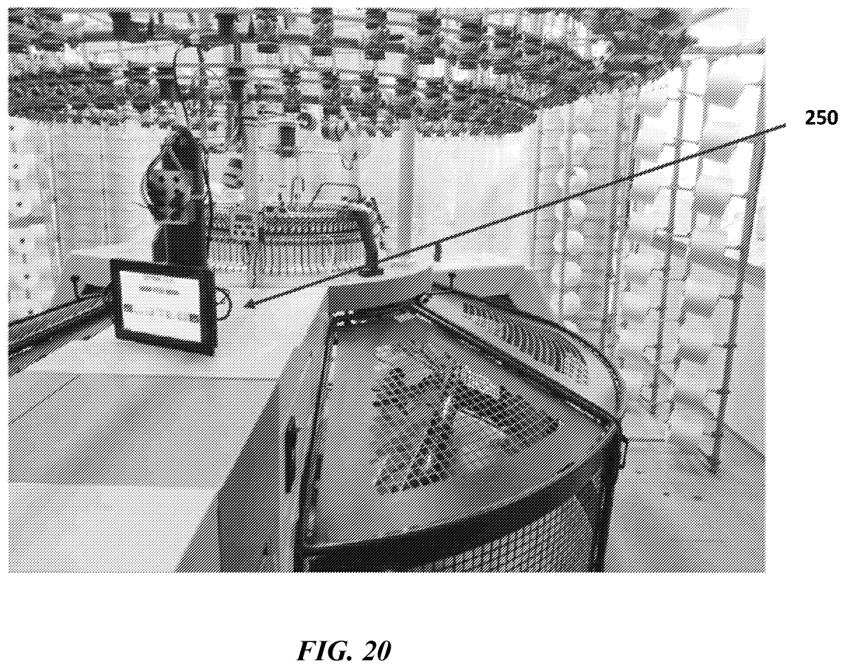

The optical detection system may be further integrated with the process control hardware or software to enable improved process control. The optical detection system may be capable of recognizing regular or repeating defects or regular substandard materials or products that may evidence a broken or malfunctioning manufacturing device. The optical detection algorithm may be programmed to alert a human operator or automatically stop a manufacturing process if a defect detection rate exceeds a threshold level or a quality control standard falls below a threshold level. As an example, FIG. 20 displays an image of a circular knitting screen with an optical detection system comprising a display terminal 250. The display terminal 250 may be capable of providing process information and warnings regarding defects or substandard materials or products to a human operator. The display terminal may provide control functions to a human operator that allow intervention in the case of a malfunctioning machine. In some cases, the display terminal 250 may comprise a handheld, mobile, or portable device (e.g., a tablet or cell phone). In some cases, the display terminal 250 may comprise a remote computer terminal. In some cases, the display terminal 250 may be connected to the optical detection system through a wireless or cloud computing link.

### Material Manufacturing Processes

The present disclosure provides optical detection systems for quality control or identifying defects during the manufacturing of materials and products. Such defects or substandard materials or products may arise during the primary manufacturing process (e.g., the knitting of a fabric) or may subsequently arise during additional secondary downstream processing (e.g., ironing or de-linting of a fabric). The products of the present invention may be broadly considered to encompass any manufactured product, including primary materials such as fabrics, sheet metals, and sheet polymers, and secondary materials produced from the utilization of primary materials, such as clothing, piping, or plastic containers. The optical detection systems may be capable of quality control or detecting defects arising from any primary or secondary manufacturing processes.

The optical detection system of the present disclosure may be utilized in a manufacturing process for any conceivable solid material. Of interest are solid, continuum materials. Such materials are produced in form factors such as sheets, nets, webs, films, tubes, blocks, rods, and discs. Materials may include textiles, metals, papers, polymers, composites, and ceramics.

Textiles may include any product produced from the spinning of fibers into long strands. Textiles may include yarns as well as products produced from the weaving or knitting of fibers into continuous fabrics. Textiles may be produced from natural or synthetic fibers. Natural fibers may include cotton, silk, hemp, bast, jute, wool, bamboo, sisal, and flax. Synthetic fibers may include nylon, rayon, polyester, acrylic, spandex, glass fiber, dyneema, orlon, and Kevlar. Textiles may be produced from a combination of fiber types such as cotton and polyester. Textiles may include additional components such as plastics and adhesives (e.g., carpet). Produced textiles may undergo additional processing such as de-sizing, scouring, bleaching, mercerizing, singeing, raising, calendering, shrinking, dyeing and printing.

Metals may include any metal, metal oxide or alloy products. Metals may include steels such as carbon steels and stainless steels. Metals may include pure metals such as copper and aluminum. Metals may include common alloys such as bronze and brass. Metals may be manufactured or cast in forms such as sheets, rods, and foils. Metals may undergo additional processing such as rolling, annealing, quenching, hardening, pickling, cutting, and stamping.

Papers may include any product produced from plant pulp such as sheet paper and cardboard. Paper products may include other materials such as plastics, metals, dyes, inks, and adhesives. Paper may undergo additional processes before or after productions such as bleaching, cutting, folding, and printing.

Polymers may include polymer materials such as thermoplastics, crystalline plastics, conductive polymers and bioplastics. Exemplary polymers may include polyethylene, polypropylene, polyamides, polycarbonates, polyesters, polystyrenes, polyurethanes, polyvinyl chlorides, acrylics, teflons, polyetheretherketones, polyimides, polylactic acids, and polysulfones. Polymers may include rubbers and elastic materials. Polymers may include copolymers or composites of multiple polymers. Polymeric materials may incorporate other materials such as paper, metal, dyes, inks, and minerals. Polymeric materials may undergo additional processes after manufacture such as molding, cutting, and dying. Plastic products may include food containers, sheets and wraps, housing materials and innumerable other consumer products.

Ceramics may include a broad range of crystalline, semi-crystalline, vitrified, or amorphous inorganic solids. Ceramic products may include earthenware, porcelain, brick and refractory materials. Ceramics may range from materials that are transparent in the visible spectrum, such as glass, to non-transparent materials in the visible spectrum, such as bricks. Ceramics may form composites with other materials such as metals and fibers. Ceramics may undergo processes such as molding, hardening, cutting, glazing, and painting during the manufacture of ceramic products.

Composites may include any material that comprises two or more other types of materials. Exemplary composites may include building materials such as particle board and concrete, as well as other structural materials such as metal-carbon fiber composites. Composite materials may undergo similar additional processing methods as their substituent components.

In some cases, the present disclosure provides optical detection systems for textile manufacturing processes. In a particular example, the present disclosure provides optical detection systems for circular knitting machines. Circular knitting machines may include any manufacturing equipment for the production of tubular fabrics. In other cases, optical detection systems may be provided for other equipment for knitting or weaving non-tubular fabrics. Optical detection systems for textile manufacturing are further described in PCT/IB2019/052806, herein incorporated by reference in its entirety.

In some examples, a knitting machine may comprise numerous parts, such as creels, pulleys, belts, brushes, tension disks, yarn guides, positive feeds, feeder rings, disk drums, pattern wheels, feeders, needle tracks, needles, sinkers, sinker rings, cam boxes, cams, cylinders, rollers, splitters, cutters, and fans. A knitting machine may be a roll-to-roll device.

In other cases, the present disclosure provides optical detection systems for other material manufacturing processes. Such processes may include the continuous or batch-wise production of other materials such as sheet metal, piping or tubing, ceramics, polymer and composites.

Optical detection systems may be utilized to monitor continuous, semi-continuous or batch production of materials, such as textiles, metals, ceramics, polymers, paper and composites. Optical detection systems may be located during or after a primary material manufacturing process, or after a secondary process following the production of a material. For example, an optical detector may be utilized to monitor the knitting or weaving of a fabric, utilized to inspect fabric as it is produced from a knitting machine, or utilized to inspect the fabric during or after any subsequent processing, such as calendering or dyeing. Optical detection systems may be utilized to monitor roll-to-roll processes for the production of flexible sheet materials such as fabrics and metal foils. Optical detection systems may be utilized to monitor the production of finished products such as garments, piping, or polymer containers.

Manufacturing equipment including optical detection systems may produce a material product at a particular rate. The production rate may be characterized in terms of length per time, area per time, volume per time, weight per time, units of product per time, or any other conceivable measure of productivity. The production rate may be an average value for processes in which the production rate varies with time. In some cases, the production process may be continuous and have minimal changes in production rate.

Optical detection systems may be applied to processes with a particular rate of material productivity. For example, a material produced from a manufacturing device (e.g., fabric from a circular knitting machine) may be produced at a particular area per time. An optical detection system may monitor equipment producing material at a rate of at least about 0.1 square meter per minute (m²/min), 0.5 m²/min, 1 m²/min, 2 m²/min, 5 m²/min, 10 m²/min, or more than about 10 m²/min. An optical detection system may monitor equipment producing material at a rate of no more than about 10 m²/min, 5 m²/min, 2 m²/min, 1 m²/min, 0.5 m²/min, 0.1 m²/min, or less than about 0.1 m²/min. In another example, a material produced from a manufacturing device (e.g., fabric from a circular knitting machine) may be produced at a particular weight per time. An optical detection system may monitor equipment producing material at a rate of at least about 1 kilogram per day (kg/day), 5 kg/day, 10 kg/day, 25 kg/day, 50 kg/day, 100 kg/day, 150 kg/day, 200 kg/day, 300 kg/day, 400 kg/day, 500 kg/day, 600 kg/day, 700 kg/day, 800 kg/day, 900 kg/day, 1000 kg/day, or more than about 1000 kg/day. An optical detection system may monitor equipment producing material at a rate of no more than about 1000 kg/day, 900 kg/day, 800 kg/day, 700 kg/day, 600 kg/day, 500 kg/day, 400 kg/day, 300 kg/day, 200 kg/day, 150 kg/day, 100 kg/day, 50 kg/day, 25 kg/day, 10 kg/day, 5 kg/day, 1 kg/day, or less than about 1 kg/day.

A material may be produced from a manufacturing device at a particular length or width. An optical detection system may have field of vision that is intended to encompass a portion or the entirety of the materials' characteristic length or width. An optical detection system may monitor a material being produced with a width of at least about 1 millimeter (mm), 5 mm, 1 centimeter (cm), 2 cm, 5 cm, 10 cm, 20 cm, 50 cm, 100 cm, 150 cm, 200 cm, or more than about 200 cm. An optical detection system may monitor a material being produced with a width of no more than about 200 cm, 150 cm, 100 cm, 50 cm, 20 cm, 10 cm, 5 cm, 2 cm, 1 cm, 5 mm, 1 mm, or less than about 1 mm.

A material may be produced from a manufacturing device (e.g., a fabric from a circular knitting machine) at a characteristic thickness. The thickness of the material may vary over the length or width of the material as it is produced. The material may have an average thickness of about 0.1 mm, 0.5 mm, 1 mm, 2 mm, 3 mm, 4 mm, 5 mm, 6 mm, 7 mm, 8 mm, 9 mm, 1 cm, 2 cm, 5 cm, 10 cm, or more than 10 cm. The material may have an average thickness of at least about 0.1 mm, 0.5 mm, 1 mm, 2 mm, 3 mm, 4 mm, 5 mm, 6 mm, 7 mm, 8 mm, 9 mm, 1 cm, 2 cm, 5 cm, 10 cm, or more than about 10 cm. The material may have an average thickness of no more than about 10 cm, 5 cm, 2 cm, 1 cm, 9 mm, 8 mm, 7 mm, 6 mm, 5 mm, 4 mm, 3 mm, 2 mm, 1 mm, 0.5 mm, 0.1 mm, or less than 0.1 mm.

Materials or products may be porous or non-porous. In some cases, the porosity of a material or product may be detectable by an imaging system. In other cases, the porosity of a material or product may not be detectable by an imaging system. The porosity of a material or product may be regular, patterned, or random. The porosity of a material or product may have a particular pore size distribution. The pore size distribution of porosity may be monomodal, bimodal, or polymodal. A porous material or product may be characterized by pores with an average size (e.g., length, width, depth, diameter) of about 10 nanometers (nm), 100 nm, 1 micrometer (μm), 10 μm, 100 μm, 250 μm, 500 μm, 1 mm, 2 mm, 3 mm, 4 mm, 5 mm, 6 mm, 7 mm, 8 mm, 9 mm, 10 mm, or more than 10 mm. A porous material or product may be characterized by pores with an average size of at least about 10 nm, 100 nm, 1 μm, 10 μm, 100 μm, 250 μm, 500 μm, 1 mm, 2 mm, 3 mm, 4 mm, 5 mm, 6 mm, 7 mm, 8 mm, 9 mm, 10 mm, or more than about 10 mm. A porous material or product may be characterized by pores with an average size of no more than about 10 mm, 9 mm, 8 mm, 7 mm, 6 mm, 5 mm, 4 mm, 3 mm, 2 mm, 1 mm, 750 μm, 500 μm, 250 μm, 100 μm, 10 μm, 1 μm, 100 nm, 10 nm, or less than 10 nm.

In some cases, manufactured textiles such as fabrics may be characterized by a particular thread count. A thread count may be defined as the number of horizontal and vertical threads per square inch of the textile material. A textile may have a thread count of about 50, 100, 150, 200, 250, 300, 350, 400, 450, 500, 550, 600, 650, 700, 750, 800, 850, 900, 950, 1000, or more than about 1000. A textile may have a thread count of at least about 50, 100, 150, 200, 250, 300, 350, 400, 450, 500, 550, 600, 650, 700, 750, 800, 850, 900, 950, 1000, or more than about 1000. A textile may have a thread count of no more than about 1000, 950, 900, 850, 800, 750, 700, 650, 600, 550, 500, 450, 400, 350, 300, 250, 200, 150, 100, 50 or less than about 50.

Materials or products may be opaque, transparent, reflective, non-reflective, or translucent. The transparency or opacity of a material or product may vary depending upon the wavelength of light impinging upon the surface of the material or product. In some cases, a material may have a characteristic transparency or opacity. The transparency or opacity may be uniform throughout the material or may vary in a regular or irregular manner. Transparency or transmittance may be defined as the total amount of light that passes through a material. A material monitored by an optical detection system may have a characteristic average transmittance of about 99.9%, 99%, 95%, 90%, 85%, 80%, 75%, 70%, 65%, 60%, 55%, 50%, 45%, 40%, 35%, 30%, 25%, 20%, 15%, 10%, 5% or less than about 5%. A material monitored by an optical detection system may have a characteristic average transmittance of at least about 99.9%, 99%, 95%, 90%, 85%, 80%, 75%, 70%, 65%, 60%, 55%, 50%, 45%, 40%, 35%, 30%, 25%, 20%, 15%, 10%, 5% or less than about 5%. A material monitored by an optical detection system may have a characteristic average transmittance of at least about 5%, 99%, 10%, 15%, 20%, 25%, 30%, 35%, 40%, 45%, 50%, 55%, 60%, 65%, 70%, 75%, 80%, 85%, 90%, 95%, 99% or more than 99.9%.

Materials or products produced from a manufacturing process may contain defects or may be substandard materials or products. Defects or substandard materials or products may arise from the raw materials used to create the material or product. For example, flaws in yarn used in a textile manufacturing process may create defects in a produced fabric where the yarn flaws are incorporated. Defect or substandard materials or products may arise from the equipment used to manufacture the material or product. For example, a broken or damaged needle in a knitting machine may regularly or irregularly incorporate defects into a fabric. Defects or substandard materials or products may arise from the process used to manufacture the material or product. For example, an unexpected shift in processing conditions (e.g., an ambient humidity level) may alter or otherwise affect the finished product from a manufacturing process. Defects or substandard materials or products may arise inherently during the production of materials or products, or may occur due to unplanned circumstances such as malfunctioning manufacturing machinery or compromised raw materials for production. Defects or substandard materials or products may arise from a human error, including improper construction of manufacturing devices, improper setup and installation of manufacturing devices, improper initialization of manufacturing devices, improper operation of manufacturing devices, and improper programming of software or other control systems. Human errors may further include failure to detect defects or substandard materials or products due to inexperience, fatigue, oversight, or other issues relating to manual visual or physical inspection

Defects may be deemed to be minor or major defects. A minor defect may comprise a defect that does not render a material or product unusable or unsellable. A major defect may comprise a defect that renders a material or product unusable, unsellable, or otherwise compromises the properties of the product. In some cases, a plurality of minor defects may comprise a major defect if the additive effect of the plurality of minor defects renders the material or product unusable, unsellable, or otherwise compromises the properties of the product. Substandard materials or products may be downgraded to a lower grade of material or product. In some cases, a substandard material or product may be unusable, unsellable, or otherwise compromised. An optical detection system may be capable of identifying major defects, minor defects, or substandard materials or products.

Defects in a material or product may occur at a characterizable rate. In some cases, defects in a material or product may occur randomly. In other cases, defects in a material or product may occur regularly. The rate of occurrence for defects may differ based upon the stage or step in manufacture of a material or product. Defects may be known to occur at differing rates during transient phases of a manufacturing process such as start-up, stopping, or changing of process feeds.

The rate of occurrence of defects or substandard materials or products may be correlated to a material or product processing parameter. For example, defects or substandard materials or products may occur at a known rate per time, at a known rate per area of material produced, at a known rate per volume of material produced, at a known rate per length of material produced, or at a known rate per weight of material produced. Minor defects and major defects may occur at differing rates. In some cases, a threshold rate of defect occurrence may occur at which a material or product is considered unusable, unsellable or otherwise compromised.

Optical detection systems may be utilized to identify defects or substandard quality in materials or products. Optical detection systems may be utilized to determine the defect rate or quality level of materials or products during a manufacturing process. An optical detection system may be capable of identifying a plurality of types of defects or quality levels. An optical detection system may be capable of identifying minor defects and major defects or substandard materials or products in a produced material or product. An optical detection system may be capable of quantifying a rate of occurrence for minor and/or major defects or substandard materials or products during the production of a material or product.

Defects in manufactured materials or products may include any damage or irregularity in the form or structure of the material or product. Defects may occur at any length scale from microscale to macroscale. A defect may be characterized by a characteristic size such as a defect length, defect width, defect depth, defect thickness, defect diameter, defect area, or defect volume. Defects in materials may include holes, cracks, fractures, pits, pores, depressions, tears, burns, stains, bends, breaks, domains of thinning, domains of thickening, stretches, compressions, bulges, deformations, discontinuities, missing substituents, blockages, occlusions, or unwanted inclusions.

A defect may have a characteristic dimension associated with it. An optical detection system may be capable of identifying a defect at a given length scale. A defect may have an average dimension (e.g., length, width, depth, thickness, diameter) of about 100 nanometers (nm), 500 nm, 1 micrometer (μm), 5 μm, 10 μm, 25 μm, 50 μm, 100 μm, 200 μm, 250 μm, 500 μm, 750 μm, 1 mm, 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more than 10 cm. A defect may have an average dimension (e.g., length, width, depth, thickness, diameter) of at least about 100 nanometers (nm), 500 nm, 1 micrometer (μm), 5 μm, 10 μm, 25 μm, 50 μm, 100 μm, 200 μm, 250 μm, 500 μm, 750 μm, 1 mm, 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more than 10 cm. A defect may have an average dimension (e.g., length, width, depth, thickness, diameter) of no more than about 10 cm, 9 cm, 8 cm, 7 cm, 6 cm, 5 cm, 4 cm, 3 cm, 2 cm, 1 cm, 9 mm, 8 mm, 7 mm, 6 mm, 5 mm, 4 mm, 3 mm, 2 mm, 1 mm, 750 μm, 500 μm, 250 μm, 200 μm, 100 μm, 50 μm, 25 μm, 10 μm, 5 μm, 1 μm, 500 nm, 100 nm, or less than 100 nm. A defect may have a characteristic average area of at least about 0.01 μm², 0.1 μm², 1 μm², 10 μm², 1 μm², 1000 μm², 10000 μm², 100000 μm², mm², 10 mm², 1 cm², 10 cm², 100 cm², or more than about 100 cm². A defect may have a characteristic average area of no more than about 100 cm², 10 cm², 1 cm², 10 mm², 1 mm², 100000 μm², 10000 μm², 1000 μm², 100 μm², 10 μm², 1 μm², 0.1 μm², 0.01 μm², or less than about 0.01 μm².

Defects may occur in a material or product at regular or irregular intervals. Defects may occur with a particular number density. For example, a material or product may have a rate of defects per unit length (μm, mm, cm, m, etc.), per unit area μm², mm², cm², m², etc.), per unit volume (μm³, mm³, cm³, m³, etc.), or per unit weight (kg, lb, ton, metric ton, etc.). In some materials or products, defects may be expected to occur at or below a particular number density. In some manufacturing processes, a material or product may be discarded if the defect rate exceeds a threshold number density. A material or product may have a defect rate with a number density (e.g., defects per unit length, defects per unit area, defects per unit volume, or defects per unit weight) of about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, 200, 300, 400, 500, 600, 700, 800, 900, 1000 or more than 1000. A material or product may have a defect rate with a number density of at least about 1, 2, 3, 4, 5, 6, 7, 8, 9, 10, 15, 20, 25, 30, 35, 40, 45, 50, 55, 60, 65, 70, 75, 80, 85, 90, 95, 100, 110, 120, 130, 140, 150, 160, 170, 180, 190, 200,300, 400, 500, 600, 700, 800, 900, 1000 or more than about 1000. A material or product may have a defect rate with a number density of no more than about 1000, 900, 800, 700, 600, 500, 400, 300, 200, 190, 180, 170, 160, 150, 140, 130, 120, 110, 100, 95, 90, 85, 80, 75, 70, 65, 60, 55, 50, 45, 40, 35, 30, 25, 20, 15, 10, 9, 8, 7, 6, 5, 4, 3, 2, 1 or less than about 1. An optical detection system may quantify the number density of defects in a manufactured material or product.

In some cases, an optical detection system may be utilized to detect defects or substandard materials or products during textile or fabric production. Detected textile or fabric defects may include: needle defects (complete, needle does not pull the yarn), contamination defects by oils, solvents, etc. (oil spots caused by so common oil leaks), needle defects (incomplete, needle incorrectly pulls the yarn), needle and sinker defects (uniformity caused by incorrect combination between sinker and needle, leading to non-uniformities), continuous elastane defect (commonly called Lycra defect, or spandex defect—it is barely detected by humans during production, only several phases after knitting), dashed elastane defects (same structure flaw as continuous elastane defect, but dashed, more rare and less visible—it is barely detected by humans during production, only several phases after knitting), contamination by other fibers (when fibers from other sources imprudently get in production, causing spots with different material), contamination by other colors (when fibers from other sources imprudently get in the production causing spots with different colors), unwanted hairiness, yarn non-uniform width and other yarn irregularities, non-uniform distance between wales (columns) or courses (rows), and non-uniformities on the production fabrics.

### Optical Detection Systems

Provided herein are systems for the detection of manufacturing defects and flaws within materials or products. Optical detection systems may be implemented at any stage or step in material or product production, including during the fabrication of the material or product and any subsequent processing steps after fabrication. Optical detection systems may be capable of detecting one or more types or modes of defect or substandard materials or products in a manufactured product or material. Optical detection systems may be physically integrated within a manufacturing device to permit defect detection or quality control in real time during the material or product manufacturing process.

An optical detection system may comprise an imaging unit, a data transmission link, and a computer system. Optionally, the optical detection system may comprise additional structural components that increase the utility of the system. The imaging unit of an optical detection device may comprise one or more light sources or illumination units and one or more detection devices. In some cases, an optical imaging system may comprise no additional light sources or illumination units.

The imaging unit of an optical detection system may broadly encompass any system capable of detecting material defects or substandard materials or products via the transmission, reflection, refraction, scattering or absorbance of light. Defects on a material or product surface or body may have a characteristic behavior in the presence of a light source. For example, holes, tears, blockages, or occlusions may all be characterized by changes in the transmission of light. In another examples, surface flaws such as pits or bulges may be detected by changes in the reflection or scattering patterns of an impinging light source. Substandard materials may be measured by bulk parameters or may be assessed by other measures such as statistical analysis of detected defects.

An imaging unit may comprise one or more light sources or illumination units. A light source or illumination unit may comprise a single light, a group of lights, or a series of lights. A light source or illumination unit in an imaging unit may comprise a substantially monochromatic light source or a light source with a characteristic frequency or wavelength range. Exemplary light sources or illumination units may include x-ray sources, ultraviolet (UV) sources, infrared sources, LEDs, fluorescent lights, and lasers. A light source or illumination unit may emit within a defined region of the electromagnetic spectrum, such as x-ray, UV, UV-visible, visible, near-infrared, far-infrared, or microwave. A light source or illumination unit may have a characteristic wavelength of about 0.1 nm, 1 nm, 10 nm, 100 nm, 200 nm, 300 nm, 400 nm, 500 nm, 600 nm, 700 nm, 800 nm, 900 nm, 1 μm, 10 μm, 100 μm, 1 mm, or more than about 1 mm. A light source or illumination unit may have a characteristic wavelength of at least about 0.1 nm, 1 nm, 10 nm, 100 nm, 200 nm, 300 nm, 400 nm, 500 nm, 600 nm, 700 nm, 800 nm, 900 nm, 1 μm, 10 μm, 100 μm, 1 mm, or more than 1 mm. A light source or illumination unit may have a characteristic wavelength of no more than about 1 mm, 100 μm, 10 μm, 1 μm, 900 nm, 800 nm, 700 nm, 600 nm, 500 nm, 400 nm, 300 nm, 200 nm, 100 nm, 10 nm, 1 nm, 0.1 nm, or less than about 0.1 nm. A light source or illumination unit may emit a range of wavelengths, for example in a range from about 1 nm to about 10 nm, about 1 nm to about 100 nm, about 10 nm to about 100 nm, about 10 nm to about 400 nm, about 100 nm to about 500 nm, about 100 nm to about 700 nm, about 200 nm to about 500 nm, about 400 nm to about 700 nm, about 700 nm to about 1 μm, about 700 nm to about 10 μm, about 1 μm to about 100 μm, or about 1 μm to about 1 mm.

An imaging unit may comprise more than one light source or illumination unit. An imaging unit may comprise more than one light source or illumination unit with similar or overlapping wavelengths or wavelength ranges. An imaging unit may comprise more than one light source or illumination unit with differing wavelengths or wavelength ranges, e.g., a UV light source and a visible light source. An imaging unit may comprise more than one light source or illumination unit to permit more than one type of defect or quality detection. An imaging unit may comprise more than one light source or illumination unit to eliminate shadowing artifacts or alter the depth of field during imaging of a material or product. In some cases, an optical imaging system may comprise no additional light sources or illumination units. In some cases, an optical detection system may be configured to collect ambient light at a detection unit.

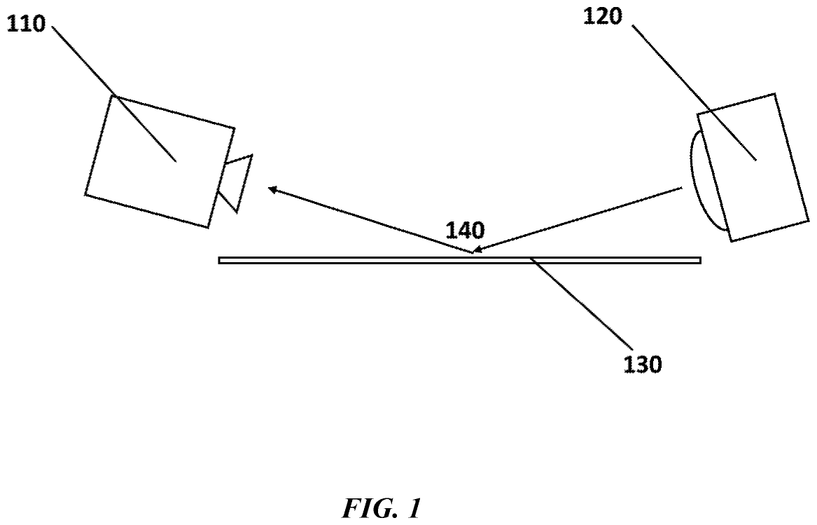

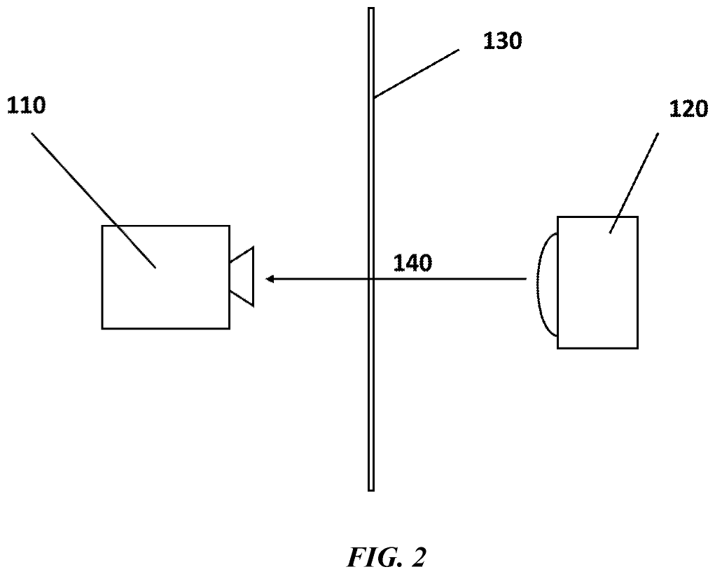

A light source or illumination unit may further comprise additional optical components for altering or shaping the emitted light. A light source may be collimated, uncollimated, polarized, or unpolarized. A light source or illumination unit may in a unidirectional or multidirectional fashion. A light source or illumination unit and/or detection unit may be oriented relative to a surface of a material. The orientation of a light source or illumination unit and/or detection unit relative to a surface of a material or product may be substantially horizontal or low angle. FIG. 1 depicts a schematic view of a light source 120 and a camera 110 oriented in a low angle fashion relative to the surface of a material or product 130. The orientation of a light source relative to a surface of a material or product may be substantially orthogonal. FIG. 2 depicts a schematic view of a light source 120 and a camera 110 oriented orthogonally to sheet material or product 130 where the light is configured to pass through the material or product 130. A light source or illumination unit and/or detection unit may be oriented relative to a plane or surface at about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, 90°, 105°, 120°, 135°, 150°, 165°, or about 180°. A light source or illumination unit and/or detection unit may be oriented relative to a plane or surface at least about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, or more than about 90°, 105°, 120°, 135°, 150°, 165°, or more than about 165°. A light source or illumination unit and/or detection unit may be oriented relative to a plane or surface at no more than about 180°, 165°, 150°, 135°, 120°, 105°, 90°, 89°, 88°, 87°, 86°, 85°, 84°, 83°, 82°, 81°, 80°, 79°, 78°, 77°, 76°, 75°, 74°, 73°, 72°, 71°, 70°, 69°, 68°, 67°, 66°, 65°, 64°, 63°, 62°, 61°, 60°, 59°, 58°, 57°, 56°, 55°, 54°, 53°, 52°, 51°, 50°, 49°, 48°, 47°, 46°, 45°, 44°, 43°, 42°, 41°, 40°, 39°, 38°, 37°, 36°, 35°, 34°, 33°, 32°, 31°, 30°, 29°, 28°, 27°, 26°, 25°, 24°, 23°, 22°, 21°, 20°, 19°, 18°, 17°, 16°, 15°, 14°, 13°, 12°, 11°, 10°, 9°, 8°, 7°, 6°, 5°, 4°, 3°, 2°, 1°, or less than about 1°.

An imaging unit may comprise one or more detection units or detectors. A detection unit or detector as used herein may serve as an image capture and/or scanning device. An imaging device may be a physical imaging device. A detection unit or detector can be configured to detect electromagnetic radiation (e.g., visible, infrared, and/or ultraviolet light) and generate image data based on the detected electromagnetic radiation. A detection unit or detector may include a charge-coupled device (CCD) sensor, photomultiplier, or a complementary metal-oxide-semiconductor (CMOS) sensor that generates electrical signals in response to wavelengths of light. The resultant electrical signals can be processed to produce image data. In some cases, the detection unit or detector may comprise a frame difference camera. Data from a frame difference camera may comprise data on the differences between two or more images. Data from a frame difference camera may comprise an image or a video. The image data generated by a detection unit or detector can include one or more images, which may be static images (e.g., visual codes, photographs), dynamic images (e.g., video), or suitable combinations thereof. The image data can be polychromatic (e.g., RGB, CMYK, HSV) or monochromatic (e.g., grayscale, black-and-white, sepia). The detection unit or detector may include additional optical components, such as shutters, filters, or lenses configured to direct light onto an image sensor.

In some embodiments, the detection unit or detector can be a camera. A camera can be a movie or video camera that captures dynamic image data (e.g., video). A camera can be a still camera that captures static images (e.g., photographs). A camera may capture both dynamic image data and static images. A camera may switch between capturing dynamic image data and static images. Although certain embodiments provided herein are described in the context of cameras, it shall be understood that the present disclosure can be applied to any suitable imaging device, and any description herein relating to cameras can also be applied to any suitable imaging device, and any description herein relating to cameras can also be applied to other types of imaging devices. A camera can be used to generate 2D images of a 3D code. The images generated by the camera can represent the projection of the 3D code onto a 2D image plane. Accordingly, each point in the 2D image corresponds to a 3D spatial coordinate in the 3D code. The camera may comprise optical elements (e.g., lens, mirrors, filters, etc). The camera may capture color images, greyscale image, infrared images, and the like. The camera may be a thermal imaging device when it is configured to capture infrared images. A detection device may capture one-dimensional (1D, two-dimensional (2D), or three-dimensional (3D) data.

A camera system may further comprise one or more optical components such as lenses. Lenses may be configured with camera systems to increase the image resolution, or increasing or decreasing the focal length of the camera system.

The detection unit or detector may capture an image or a sequence of images at a specific image size. In some embodiments, the image size may be defined by the number of pixels in an image. In some embodiments, the image size may be greater than or equal to about 352×420 pixels, 480×320 pixels, 720×480 pixels, 1280×720 pixels, 1440×1080 pixels, 1920×1080 pixels, 2048×1080 pixels, 3840×2160 pixels, 4096×2160 pixels, 7680×4320 pixels, or 15360×8640 pixels. In some embodiments, the camera may be a 4K camera or a camera with a higher image size.

The detection unit or detector may capture a sequence of images at a specific capture rate. In some embodiments, the sequence of images may be captured standard video frame rates such as about 24p, 25p, 30p, 48p, 50p, 60p, 72p, 90p, 100p, 120p, 300p, 50i, or 60i. In some embodiments, the sequence of images may be captured at a rate less than or equal to about one image every 0.0001 seconds, 0.0002 seconds, 0.0005 seconds, 0.001 seconds, 0.002 seconds, 0.005 seconds, 0.01 seconds, 0.02 seconds, 0.05 seconds. 0.1 seconds, 0.2 seconds, 0.5 seconds, 1 second, 2 seconds, 5 seconds, or 10 seconds. In some embodiments, the capture rate may change depending on user input and/or the target application.

The detection unit or detector may have a characteristic image resolution. The image resolution may be defined as the length at which image features are optically resolvable. For example, a camera with an image resolution of 0.1 mm may be capable of distinguishing features of 0.1 mm or larger. A detection unit or detector may have an image resolution of about 0.01 mm, 0.05 mm, 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, or more than about 5 mm. A detection unit or detector may have an image resolution of at least about 0.01 mm, 0.05 mm, 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, or more than about 5 mm. A detection unit or detector may have an image resolution of no more than about 5 mm, 4 mm, 3 mm, 2 mm, 1 mm, 0.9 mm, 0.8 mm, 0.7 mm, 0.6 mm, 0.5 mm, 0.4 mm, 0.3 mm, 0.2 mm, 0.1 mm, 0.05 mm, 0.01 mm, or less than about 0.01 mm.

The detection unit or detector may have adjustable parameters. Under differing parameters, different images may be captured by the detection unit or detector while subject to identical external conditions (e.g., location, lighting). The adjustable parameter may comprise exposure (e.g., exposure time, shutter speed, aperture, film speed), gain, gamma, area of interest, binning/subsampling, pixel clock, offset, triggering, ISO, etc. Parameters related to exposure may control the amount of light that reaches an image sensor in the imaging device. For example, shutter speed may control the amount of time light reaches an image sensor and aperture may control the amount of light that reaches the image sensor in a given time. Parameters related to gain may control the amplification of a signal from the optical sensor. ISO may control the level of sensitivity of the camera to available light. Parameters controlling for exposure and gain may be collectively considered and be referred to herein as EXPO.

In some alternative embodiments, a detection unit or detector may extend beyond a physical imaging device. For example, a detection unit or detector may include any technique that is capable of capturing and/or generating images or video frames of codes. In some embodiments, the detection unit or detector may refer to an algorithm that is capable of processing images obtained from another physical device.

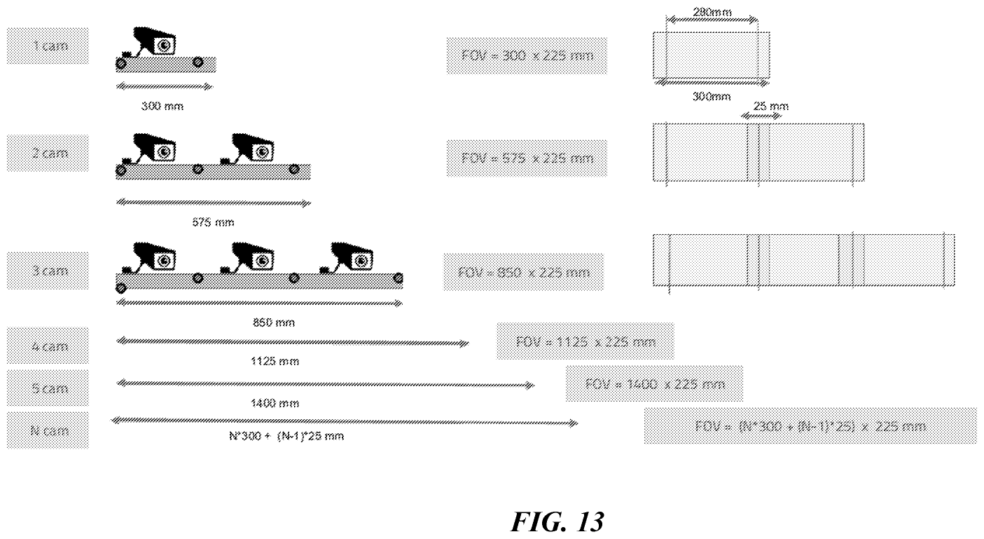

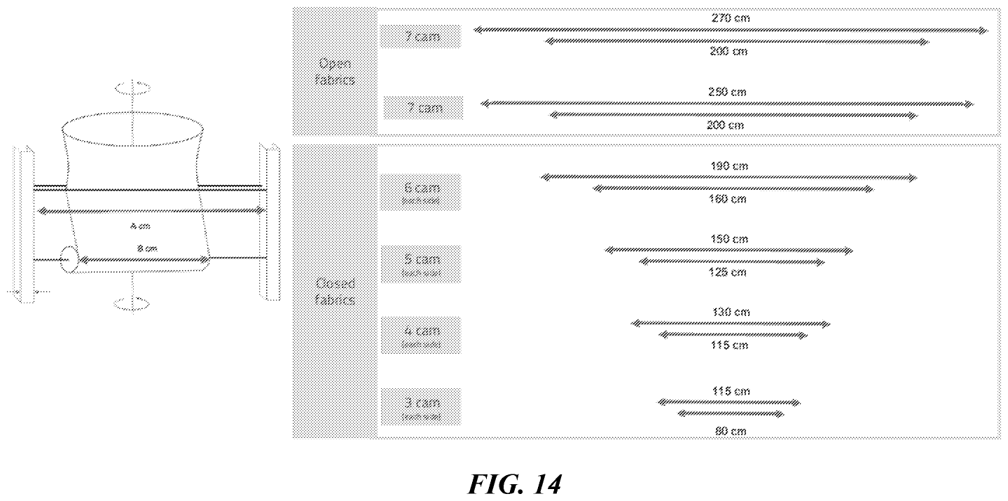

Detection units, detectors or sensors may be arranged in a serial fashion to increase the field of vision. Detection devices may be arranged such that each devices' respective field of vision overlaps with the field of vision of a neighboring device. Detection devices may be arranged such that each devices' field of vision is immediately adjacent to the field of vision of a neighboring device. FIG. 13 depicts exemplary fields of vision that can be achieved with one or more camera units where each camera has a 300 mm by 225 mm field of vision and the cameras are configured to overlap by 25 mm. FIG. 14 demonstrates how camera configurations may be chosen for defect analysis or quality control of fabric manufacturing processes based upon the width of the manufactured fabric material.

An item having a visual code as described herein can be optically identified and/or tracked in real-time by a visual scanning system. Optical tracking has several advantages. For example, optical tracking allows for wireless ‘sensors’, is less susceptible to noise, and allows for many objects (e.g., different types of objects) to be tracked simultaneously. The objects can be depicted in still images and/or video frames in a 2D or 3D format, can be real-life and/or animated, can be in color, black/white, or grayscale, and can be in any color space. In some cases, data from linear cameras (1D signal) can be aggregated in order to build a 2D signal that captures the full detail of the 2D target region.

An optical detection system may comprise a data transmission link to facilitate the transfer of imaging data from the imaging unit to a computer system. A data transmission link may comprise a hardwired link or a wireless link. A hardwired link may include any type of cable capable of transmitting a digital or electrical signal from the imaging unit to the computer system. A data transmission link may include additional components such as hubs, routers, antennae, modems, and receivers.

An optical detection system may comprise a computer system. A computer system may be configured to receive data (e.g., 1D or 2D images) from an imaging unit and interpret the data to identify and/or quantify the incidence of defects during a manufacturing process. A computer system may comprise one or more algorithms for interpreting imaging data to determine the presence of defects or substandard materials or products in a manufactured material or product. An algorithm may be a standalone software package or application for defect detection. An algorithm may be integrated with other operational software for a manufacturing device, such as process control software. An algorithm for defect detection or quality control may be configured to affect the operation of a manufacturing process. For example, a defect detection algorithm or quality control algorithm may be configured to stop or slow a manufacturing process if one or more defects are detected in a material or product or a material or product falls beneath a quality control standard for a certain amount of time. A defect detection algorithm or quality control algorithm may be capable of identifying one or more types of defects or quality levels in a manufactured material or product. A defect detection algorithm or quality control algorithm may be capable of identifying a root cause of one or more types of defects or substandard materials or products based upon the number of defects, the number density of defects, the frequency of defects, the regularity of defects, the size of defects, the shape of defects, or any other relevant parameters that may be calculated by the algorithm. A defect detection algorithm or quality control algorithm may utilize defect data to stop or alter a manufacturing process. A defect detection algorithm or quality control algorithm may correct one or more processing parameters to reduce the rate of defect formation or improve the quality of a material or product during a manufacturing process. A defect detection algorithm or quality control algorithm may identify an unusable, unsellable, or otherwise compromised material or product obtained from a manufacturing process. A material or product may be discarded, repaired, or reprocessed based upon the identification of one or more defects or substandard quality by a defect detection algorithm or quality control algorithm. A defect detection algorithm or quality control algorithm may comprise a trained algorithm or a machine learning algorithm.

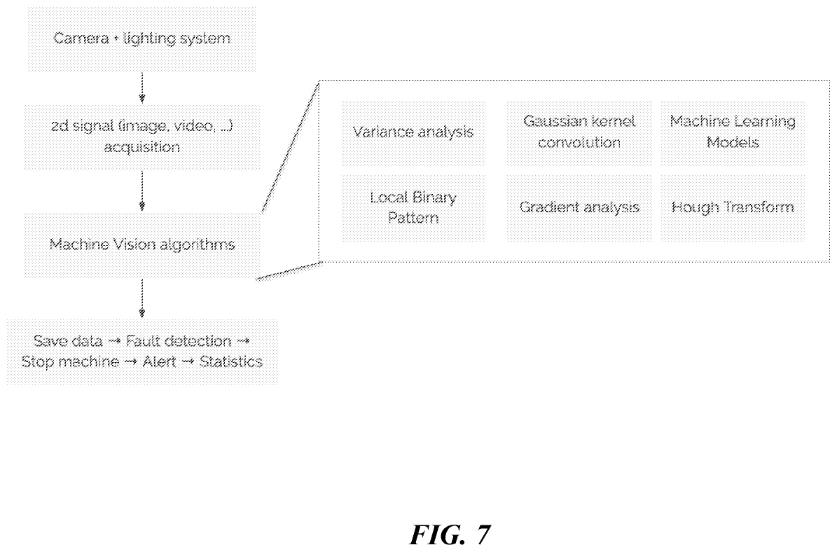

A defect detection algorithm or quality control algorithm may comprise a trained algorithm or a machine learning algorithm. In some cases, the defect detection algorithm or quality control algorithm may comprise a machine vision algorithm. The defect detection algorithm or quality control algorithm may comprise various sub-algorithms or subroutines such as variance analysis, Gaussian kernel convolution, machine learning model (e.g., section profile analysis), local binary pattern analysis, gradient analysis, and Hough transform analysis. FIG. 7 depicts a block diagram showing the stages of data acquisition and image analysis in a conceptual defect detection algorithm or quality control algorithm. Imaging data may be saved for future analysis or re-analyzed to improve a machine learning algorithm as the algorithm skill increases.

An optical detection system may comprise further mechanical and/or electrical components. Structural components may be utilized to secure components of the optical detection system in, on, or around a manufacturing device. The optical detection system may be a modular system. The optical detection system may be an adjustable system capable of adapting to a range of manufacturing devices. An optical detection system may be a customized device that is specifically designed for a particular manufacturing device. A structural component may comprise a mount that attaches one or more components of an imaging unit to a manufacturing device. In some cases, components may be configured in static positions relative to the output of a manufacturing device. In some cases, components of an imaging unit may be mounted to static supports by motive components such that the static support may remain fixed while the imaging unit component may be repositioned during operation. In other cases, an imaging unit component may be mounted to a moving component of a manufacturing device such that the component is moved by the movement of the manufacturing device. For example, a camera unit may be mounted to a rotational element of a circular knitting machine such that the camera rotates during operation of the knitting machine. In some cases, an imaging unit component may be configured to move with a velocity that matches the velocity of a moving portion of the manufacturing machine. In some cases, an imaging unit component may be configured to move with a differing velocity from that of a moving portion of the manufacturing machine. For example, an imaging unit may be directly coupled to a rotating portion of a circular knitting machine, or the imaging unit may be indirectly coupled to the rotating portion by a gear assembly to cause the imaging unit to rotate at a faster or slower speed than the rotating portion.

An optical detection may comprise additional mechanical components. Mechanical components may include structural components, motive devices, and shielding components. Structural components may include any components that hold, attach, or support components of the optical detection system. Structural components may also include devices for other mechanical purposes such as vibration dampening. Structural components may include bars, struts, clamps, brackets, rods, pins, plates, screws, nails, bolts, rivets, washers, and nuts. Motive devices may include motorized stages or carts for moving components translationally or rotationally. Motive components may be used to alter or reposition components (e.g., cameras, light sources) before, during or after the collection of imaging data. In some cases, motive components may be used to configured or optimize the position of components of the optical detection system after installation in a manufacturing device. In other cases, motive components may be utilized to alter the position of system components during data collection. An optical detection system may comprise shielding components to protect the system from environmental hazards such as heat, contaminants, and interfering ambient light sources.

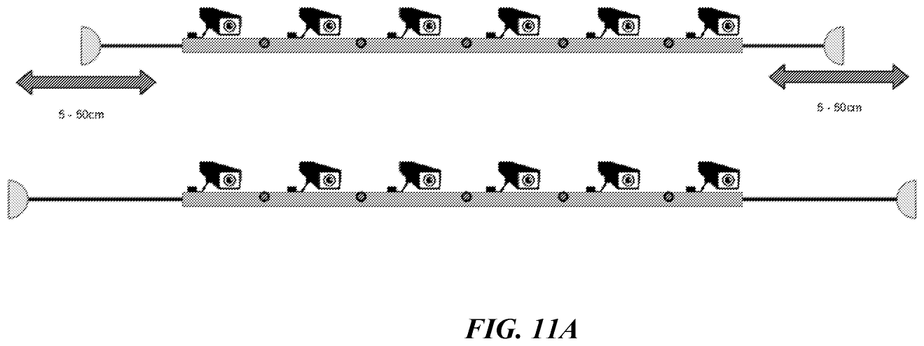

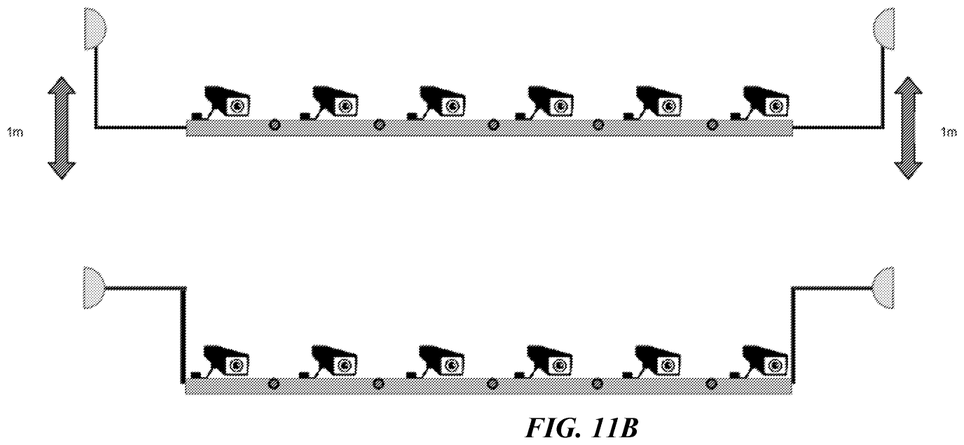

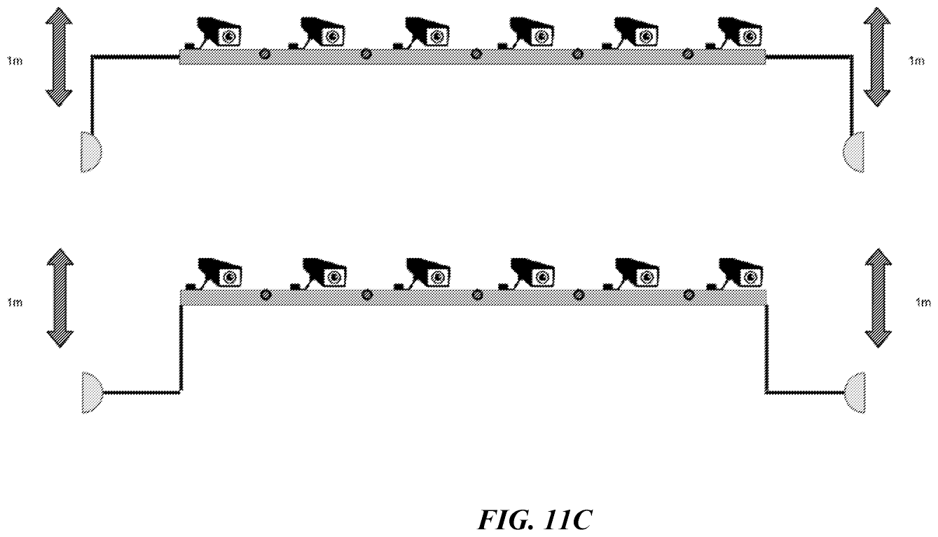

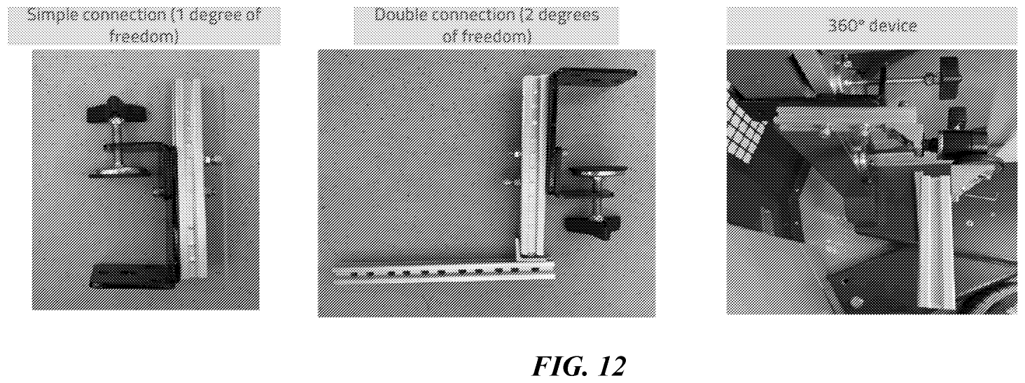

The mechanical components of an optical detection system may be adjustable or modular. Components intended to secure, couple or attach an imaging system to a manufacturing device may contain adjustable components that permit adaptation between systems. FIGS. 11A-11C depict various configurations of a support bar for imaging units with horizontal and vertical position adjustments. FIG. 11A depicts a support bar with only horizontal adjustment. This support bar may be coupled to opposing walls of a manufacturing device with the horizontal adjustments permitting adaptation between differing devices. FIGS. 11B and 11C support bars with vertical height adjustments in the downward (FIG. 11B) and upward (FIG. 11C) directions. Such a configuration would permit adjustment of the imaging unit relative to the manufactured material or product, thereby permitting alteration of the target region. Adjustable components ma further incorporate manual, automated or user-controlled adjustments to permit adjustment of the imaging unit before, during, or after utilization. FIG. 12 shows additional components for adjusting components of the imaging unit (e.g., cameras, light sources). Structural components may permit 1 degree of freedom for adjustment, 2 degrees of freedom for adjustment, or permit up to 360° of rotational adjustment.

In some cases, an imaging unit may be coupled to a manufacturing machine by a structural support. The structural support holding the imaging unit may be coupled to a portion of the manufacturing device such as a wall, lateral support, roof, floor, or surface. The structural support holding the imaging support may be coupled to a stationary or fixed portion of the manufacturing machine. The structural support holding the imaging support may be coupled to a rotating, translating, oscillating, or otherwise moving portion of a manufacturing machine, such as a rotating shaft or a rotating support. In some cases, the structural support may comprise a standalone structure that is not directly coupled to the manufacturing machine.

An optical detection system may further comprise electrical components. Electrical components may provide power to any component of the system requiring electrical energy. Exemplary electrical components may include wiring, one or more batteries, chargers for the one or more batteries, plugs, sockets, and insulating shielding. In order to provide power to the optical detection system, other electro-mechanical components may be added and/or modified, including slip rings (which may comprise pneumatic, hydraulic, optical, or electrical joints), alternators, dynamos, generators for inductive charging, and/or other methods of wireless power transmission. These power sources can be used alone, or compatibly or in combination with each other, for example, by combining any power generation mechanism with one or more batteries that can be used to power the optical detection system.

In some embodiments, the mechanical components of the manufacturing machine can be modified in order to enable a proper inspection of the manufactured materials or any defects associated with the manufactured materials. This may include, for example, adding additional walls, supports structures, shafts, roofs, floors, or surfaces, or modifying one or more components or structural aspects of the mechanical driving transmission system.

In some embodiments, the detection system may be configured to acquire or receive additional information about the manufactured material or the manufacturing process used to generate the manufactured material, such as speed of production, scrap rate, manufacturing machine performance and machine state, production amounts, as well as environmental conditions such as temperature, humidity, lighting conditions, noise levels, and/or air quality (e.g., a presence or concentration of various particulates in the air or an amount of smoke produced or released during the manufacturing process). The additional information about the manufactured material or the manufacturing process may be obtained using one or more sensors, or from one or more data sources or repositories comprising information about the manufactured material or one or more components or subsystems of the detection system or the material fabrication machine. In such cases, the detection system may be configured to use such additional information about the manufactured material or the manufacturing process to aid in and/or enhance the detection of various defects or a substandard quality of materials or products produced using a manufacturing process.

In some cases, the detection system may be configured to use the additional information about the manufactured material or the manufacturing process to adjust a calibration and/or an operation of the imaging unit described herein. The imaging unit may be used to capture images or videos corresponding to one or more target regions on a material sheet or any other type of product produced using a material fabrication machine. In some cases, the detection system may be configured to use the additional information about the manufactured material or the manufacturing process to adjust an operation of the material fabrication machine. In any of the embodiments described herein, the detection system may be configured to adjust an operation of one or more components or subsystems of the detection system (e.g., an imaging unit, an illumination unit, and/or an image analysis unit of the detection system) based on the additional information about the manufactured material or the manufacturing process to aid in and/or enhance the detection of various defects or a substandard quality of materials or products produced using a manufacturing process. In some cases, the detection system may be configured to implement a feedback loop for adjusting and fine tuning an operation of the imaging unit, the illumination unit, the image analysis unit, and/or the material fabrication machine based on the additional information associated with the manufactured material or the manufacturing process.

In some cases, the feedback loop may comprise, for example, an open-loop control scheme or a closed-loop control scheme. In some non-limiting examples, the feedback loop may be implemented using one or more controllers (e.g., a proportional-integral-derivative controller (PID controller), a proportional-integral controller (PI controller), a proportional-derivative controller (PD controller), a proportional controller, an integral controller, a derivative controller, or a fuzzy logic controller). In some cases, the feedback loop and any adjustments associated with the feedback loop can be implemented in real-time as the additional information is received or detected. As described above, real-time may refer to a simultaneous or substantially simultaneous occurrence of an event or action (e.g., receiving or detecting the additional information) with respect to an occurrence of another event or action (e.g., adjustment of an operation of the detection system or one or more components of the detection system). A real-time action or event may be performed within a response time of less than one or more of the following: ten seconds, five seconds, one second, tenth of a second, hundredth of a second, a millisecond, or less relative to at least another event or action.

In any of the embodiments described herein, one or more artificial intelligence or machine learning based algorithms can be used to implement adaptive control of the detection system (or one or more components or subsystems of the detection system) based on the additional information. The machine learning algorithm may be, for example, an unsupervised learning algorithm, a supervised learning algorithm, or a combination thereof. In some embodiments, the machine learning algorithm may comprise a neural network (e.g., a deep neural network (DNN)). In some embodiments, the deep neural network may comprise a convolutional neural network (CNN). The CNN may be, for example, U-Net, ImageNet, LeNet-5, AlexNet, ZFNet, GoogleNet, VGGNet, ResNet18, or ResNet, etc. In some cases, the neural network may be, for example, a deep feed forward neural network, a recurrent neural network (RNN), LSTM (Long Short Term Memory), GRU (Gated Recurrent Unit), an autoencoder, a variational autoencoder, an adversarial autoencoder, a denoising autoencoder, a sparse autoencoder, a Boltzmann machine (BM), a restricted Boltzmann machine (RBM or Restricted BM), a deep belief network, a generative adversarial network (GAN), a deep residual network, a capsule network, or an attention/transformer networks. In some embodiments, the neural network may comprise one or more neural network layers. In some instances, the neural network may have at least about 2 to 1000 or more neural network layers. In some cases, the machine learning algorithm may be configured to implement, for example, a random forest, a boosted decision tree, a classification tree, a regression tree, a bagging tree, a neural network, or a rotation forest.

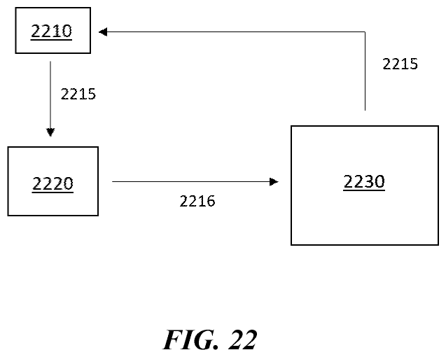

FIG. 22 illustrates an example of a feedback loop that can be implemented to enhance a detection of defects or aid in quality control of a manufacturing process. In some cases, one or more sensors 2210 may be used to detect information 2215 about the manufactured material or the manufacturing process used to generate the manufactured material. Such information 2215 may comprise, for example, speed of production, scrap rate, manufacturing machine performance and machine state, production amounts, as well as environmental conditions such as temperature, humidity, lighting conditions, noise levels, and/or air quality (e.g., a presence or concentration of various particulates in the air or an amount of smoke produced or released during the manufacturing process). The one or more sensors 2210 may be operatively coupled to a processing unit 2220 that is configured to receive the information 2215 associated with the manufactured material and/or the manufacturing process and to use the information 2215 to provide one or more commands or instructions 2216 for adjusting an operation of one or more components or subsystems of a detection system 2230. The detection system 2230 may comprise any of the detection systems described herein. The detection system 2230 may be configured to (i) detect one or more defects present within a manufactured material and/or (ii) perform quality control for one or more manufacturing processes used to produce a material or product.

### Method of Detecting Defects During Manufacturing Processes

Provided herein are methods for detecting defects or substandard quality in materials or products using optical detection systems. The optical detection system may comprise an imaging unit connected to a computer system by a data transmission link. An algorithm performed on the computer system may interpret data transmitted from the imaging unit by the data transmission link to detect the presence or absence of defects or substandard quality in a material or product during a manufacturing process. In some cases, the imaging unit is calibrated to a target region relative to the material or product, and the imaging unit is configured to capture image data of the target region as the material or product is produced by the material fabrication machine.

Calibration of a target region of a material or product may comprise any process that ensures the proper functioning of the imaging unit during defect detection. Calibration processes may include processes such as calibrating the output of a light source, adjusting the intensity of a light source, adjusting the direction or position of a light source, adjusting the direction or position of a detection unit or detector, or adjusting sensor parameters in a detection unit or detector (e.g., gain, exposure time). In some cases, calibration of a target region of a material may comprise initializing the imaging unit to its baseline settings. In some cases, calibration of a target region may comprise resetting the imaging unit to its baseline settings. In some cases, calibration of a target region may comprise adjusting the imaging unit to a known or predetermined setting. The settings for an imaging unit may comprise parameters describing the physical characteristics of components within the imaging unit (e.g., light intensity, light direction, sensor direction, etc.) and parameters describing the collection of data by the sensing portion of the imaging unit (e.g., exposure time, focal depth, field of view, frame rate, etc.).

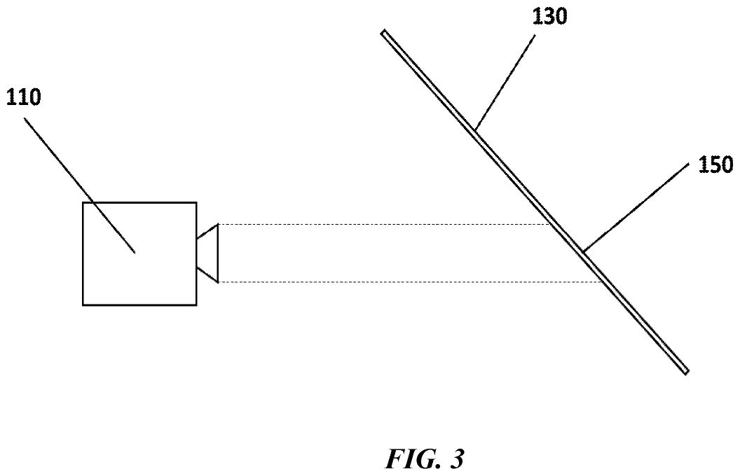

An imaging unit may be calibrated relative to a target region of a material or product. A target region may be any surface of a material or product during a manufacturing process. A target region may be flat, planar, or curved. A target region may have a particular shape, e.g., rectangular, square, circular, oval, etc. Calibration may be performed on a static target region or a dynamic target region. A target region may be spatially fixed relative to a continuously produced material or product. For example, a target region may comprise a rectangular region in a camera field of vision through which a fabric material passes. A surface of a material or product comprising a target region for an imaging unit may not be oriented orthogonal to a detection unit or light source. FIG. 3 depicts a schematic view of a camera device 110 viewing a sheet of a material 130 that is oriented at an angle relative to the camera device 110. The projection of the field of view of the camera device 110 on the sheet of material 130 creates a target region 150 with an effective area that is larger than the area of the field of view.

Calibration of a target region may occur at the start of a manufacturing process. Calibration of a target region may occur during a manufacturing process. Calibration of a target region may occur periodically or at regular intervals during a manufacturing process. Calibration of a target region may be performed under control of an imaging software package or algorithm. Calibration of a target region may involve reference to known or pre-existing sample or data set. For example, the calibration of an imaging unit monitoring a fabric production process may calibrate the initial focal depth or illumination intensity based upon a pre-existing data set for the same fabric material and manufacturing machine. Calibration of a target region by an imaging unit may be fully automated. Calibration of a target region may be performed or confirmed by an operator.

An imaging unit may be considered calibrated if a set of one or more system parameters (e.g., focal depth, light intensity, frame rate) fall within a threshold difference from the optimal value. Calibration may be performed on a set of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more than 30 system parameters. Calibration may be performed on a set of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or more than 30 system parameters. Calibration may be performed on a set of no more than about 30, 29, 28, 27, 26, 25, 24, 23, 22, 21, 20, 19, 18, 17, 16, 15, 14, 13, 12, 11, 10, 9, 8, 7, 6, 5, 4, 3, 2, or less than about 2 system parameters. A system parameter may be considered calibrated if the measured value of the system parameter falls within about 20%, 15%, 10%, 9%, 8%, 7%, 6%, 5%, 4%, 3%, 2%, 1%, 0.5%, 0.1%, 0.05%, 0.01%, or less than about 0.01% of an optimal value. A system parameter may be considered calibrated if the measured value of the system parameter falls within no more than about 20%, 15%, 10%, 9%, 8%, 7%, 6%, 5%, 4%, 3%, 2%, 1%, 0.5%, 0.1%, 0.05%, 0.01%, or less than about 0.01% of an optimal value.

An optical detection system may operate in various data collection and analysis modes. In some cases, an optical detection system may operate continuously or in real time. Continuous or real time defect detection may comprise the continual collection and export of data to an analysis algorithm. Continual collection of data may include any mode of operation where a detection unit or detector is exposed to incident light at all times during data collection. For example, for manufacturing processes where a material or product is continually produced (e.g., fabric knitting), an optical detection system may operate in a continuous mode. In some cases, an optical detection system may collect data in a segmented mode. Segmented data collection may comprise a mode of operation where a detection unit or detector is activated or deactivated at one or more time intervals during operation of the imaging unit. For example, a manufacturing process where a material or product is produced in a batch or semi-batch configuration (e.g., metal forging) may only have activated detectors during time intervals when output is passing through the field of vision.

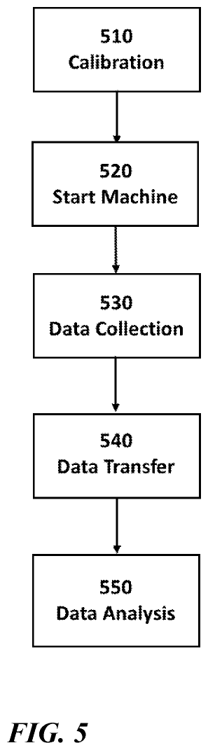

FIG. 5 depicts a mode of operation for an optical detection system in accordance with some embodiments of the present invention. In a first step 510, an imaging unit may be calibrated to a target region of a material or product. In a second step 520, a manufacturing process or device may be started. In a third step 530, data collection from the imaging unit may begin. In a fourth step 540, data from the imaging unit may be exported to a computer system. In a fifth step 550, data from the imaging system may be analyzed by an algorithm of the computer system to determine the presence of absence of defects or substandard quality in the manufactured product or material. The skilled person will recognize additional variations of the mode of operation depicted in FIG. 5. For example, calibration may occur after a process or machine has been started. It will also be recognized that modes of operation may include additional intermediate steps such as recalibration of the imaging unit, movement of the imaging unit, and slowdown or stoppage of the process or machine.

The detection of defects or substandard quality in a manufactured material or product may lead to one of several outcomes. In some cases, the detection of defects or substandard quality in a manufactured material or product may lead to more than one outcome. The detection of one or more defects or substandard quality in a manufactured material or product may cause the stoppage of a manufacturing process or device. The detection of one or more defects or substandard quality in a manufactured material or product may prompt the repair of a manufacturing device. The detection of one or more defects or substandard quality in a manufactured material or product may prompt the recalibration of a manufacturing device. The detection of one or more defects or substandard quality in a manufactured material or product may prompt the replacement of a feed to a manufacturing process or machine. The detection of one or more defects or substandard quality in a manufactured material or product may lead to a material or product being discarded. The detection of one or more defects or substandard quality in a manufactured material or product may lead to a material or product being repaired. The detection of one or more defects or substandard quality in a manufactured material or product may lead to a material or product being reproduced. The detection of one or more defects or substandard quality in a manufactured material or product may prompt intervention by a human operator of the manufacturing process or device. The detection of one or more defects or substandard quality in a manufactured material or product may prompt intervention by a control system in a manufacturing process or device. A quality assurance protocol may comprise the identification and quantitation of defects or substandard quality in a manufactured material or product by an optical detection system.

### Computer Systems

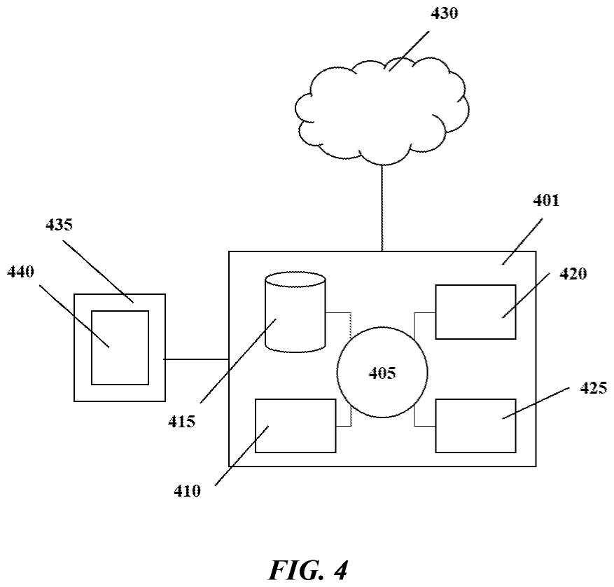

The present disclosure provides computer systems that are programmed to implement methods of the disclosure. FIG. 4 shows a computer control system 401 that is programmed or otherwise configured to detect the presence of absence of defects in a manufactured material or product based on imaging data. The computer control system 401 can regulate various aspects of the methods of the present disclosure, such as, for example, methods of analyzing image data. The computer control system 401 can be implemented on an electronic device of a user or a computer system that is remotely located with respect to the electronic device. The electronic device can be a mobile electronic device.

The computer system 401 includes a central processing unit (CPU, also “processor” and “computer processor” herein) 405, which can be a single core or multi core processor, or a plurality of processors for parallel processing. The computer control system 401 also includes memory or memory location 410 (e.g., random-access memory, read-only memory, flash memory), electronic storage unit 415 (e.g., hard disk), communication interface 420 (e.g., network adapter) for communicating with one or more other systems, and peripheral devices 425, such as cache, other memory, data storage and/or electronic display adapters. The memory 410, storage unit 415, interface 420 and peripheral devices 425 are in communication with the CPU 405 through a communication bus (solid lines), such as a motherboard. The storage unit 415 can be a data storage unit (or data repository) for storing data. The computer control system 401 can be operatively coupled to a computer network (“network”) 430 with the aid of the communication interface 420. The network 430 can be the Internet, an internet and/or extranet, or an intranet and/or extranet that is in communication with the Internet. The network 430 in some cases is a telecommunication and/or data network. The network 430 can include one or more computer servers, which can enable distributed computing, such as cloud computing. The network 430, in some cases with the aid of the computer system 401, can implement a peer-to-peer network, which may enable devices coupled to the computer system 401 to behave as a client or a server.

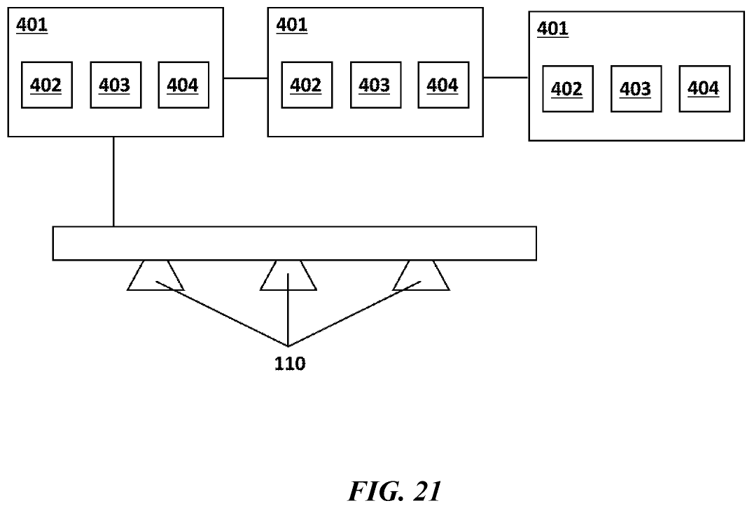

In some cases, the computer system 401 may comprise a graphics processor unit (GPU) 402 and/or a user interface (UI) 403 and/or an actuator 404. FIG. 21 shows a series of connected computer systems 401 linked to a series of camera units 110. The actuator 404 may be capable of sending and/or receiving signal from external devices (e.g., manufacturing machines). The computer system 401 may comprise an external or internal GPU 402. In some cases, a system may comprise more than one computer system 401 or subcomponent of a computer system. A system with multiple computer systems 401 or multiple GPUs 402 may be arranged in a parallel or series architecture. Computer systems 401 or GPUs 402 may be arranged to increase or optimize the computational power of a system for an intended application. In some cases, one or more computer systems 401 may send or receive data from an external device (e.g., an optical detection system comprising multiple camera units 110).

The CPU 405 can execute a sequence of machine-readable instructions, which can be embodied in a program or software. The instructions may be stored in a memory location, such as the memory 410. The instructions can be directed to the CPU 405, which can subsequently program or otherwise configure the CPU 405 to implement methods of the present disclosure. Examples of operations performed by the CPU 405 can include fetch, decode, execute, and writeback.

The CPU 405 can be part of a circuit, such as an integrated circuit. One or more other components of the system 401 can be included in the circuit. In some cases, the circuit is an application specific integrated circuit (ASIC).

The storage unit 415 can store files, such as drivers, libraries and saved programs. The storage unit 415 can store user data, e.g., user preferences and user programs. The computer system 401 in some cases can include one or more additional data storage units that are external to the computer system 401, such as located on a remote server that is in communication with the computer system 401 through an intranet or the Internet.

The computer system 401 can communicate with one or more remote computer systems through the network 430. For instance, the computer system 401 can communicate with a remote computer system of a user (e.g., a user controlling the manufacture of a material or product). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 401 via the network 430.

Methods as described herein can be implemented by way of machine (e.g., computer processor) executable code stored on an electronic storage location of the computer system 401, such as, for example, on the memory 410 or electronic storage unit 415. The machine executable or machine readable code can be provided in the form of software. During use, the code can be executed by the processor 405. In some cases, the code can be retrieved from the storage unit 415 and stored on the memory 410 for ready access by the processor 405. In some situations, the electronic storage unit 415 can be precluded, and machine-executable instructions are stored on memory 410.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 401 can include or be in communication with an electronic display 435 that comprises a user interface (UI) 440 for providing, for example, the display of defect-related data or quality control parameters. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 405. The algorithm can, for example, collect data from an imaging unit and analyze the data for evidence of defects in a manufactured material or product

### EXAMPLES

### Example 1—Rotating Optical Detection System

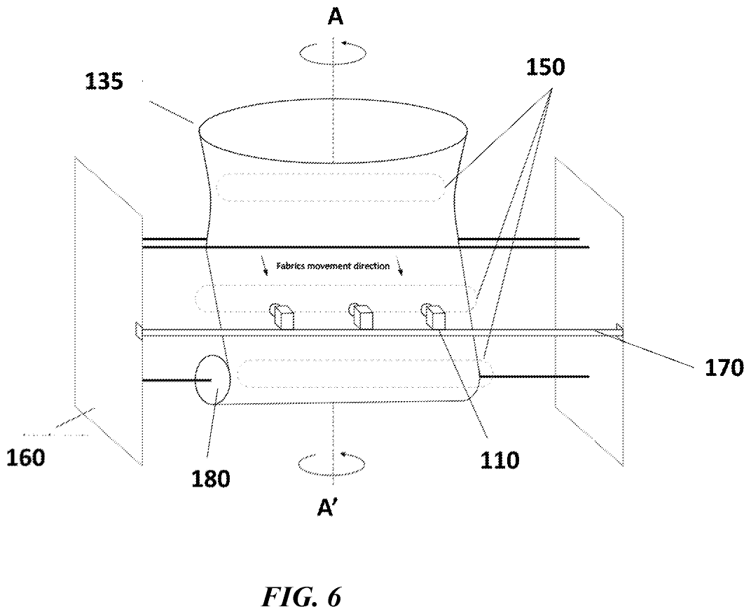

FIG. 6 depicts an exemplary imaging unit for an optical detection system for monitoring a fabric production process for a circular knitting machine. The knitting machine is configured to produce a tubular fabric 135 by knitting yarn while rotating about a central axis A-A′, then feeding the produced fabric onto a storage roll 180. The knitting machine further comprises lateral supports 160 to which a horizontal mounting bar 170 is attached. One or more cameras 110 are fixed to the horizontal mounting bar 170. The horizontal mounting bar 170 may be adjusted vertically on the lateral supports 160 to change the location of the target region 150 for defect detection. The target region 150 may be located near the upper knitting region, beneath the knitting region, or at the storage roll 180.

### Example 2—Optical Detection System with Light Sources

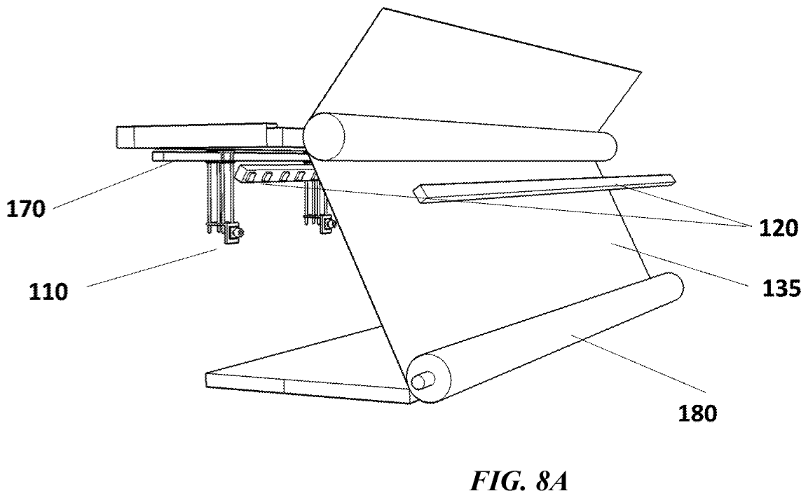

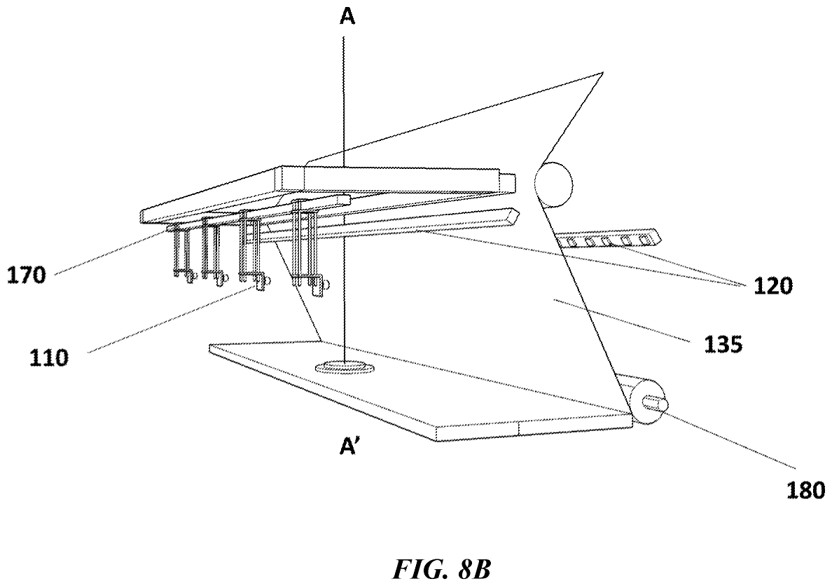

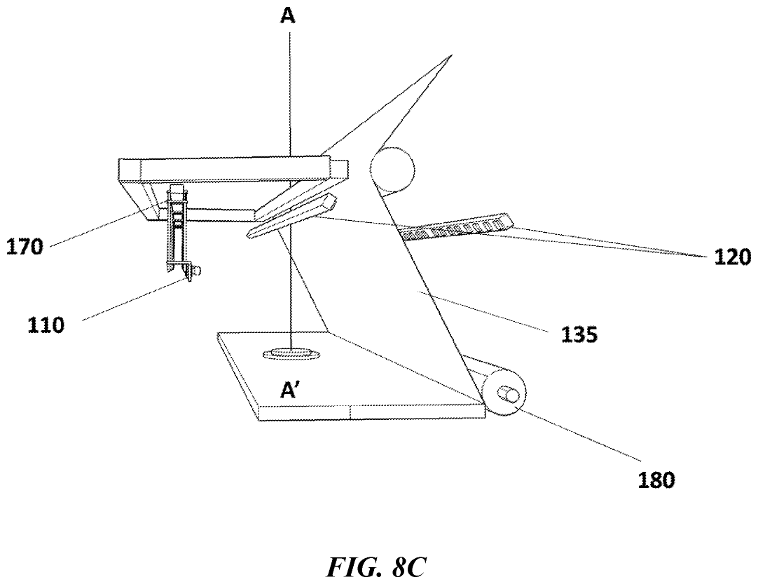

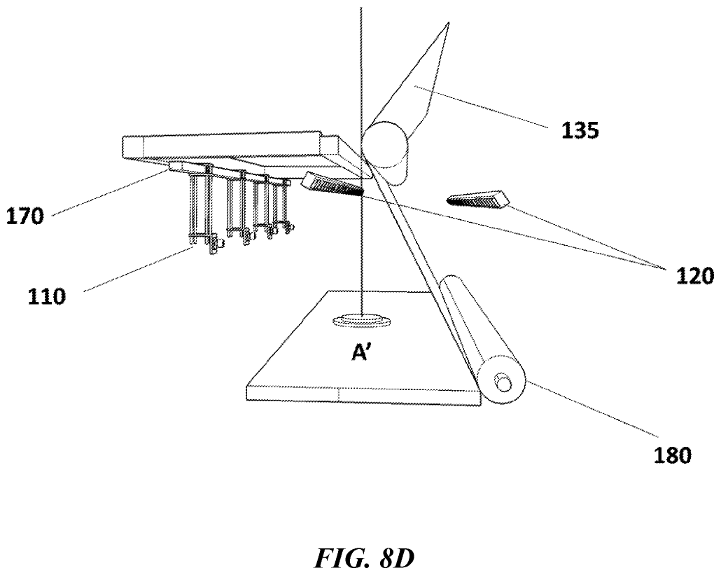

FIGS. 8A-8D depict schematic views of the configuration of an imaging unit for an optical detection system in a rotating circular knitting machine. The circular knitting machine may rotate about an axis A-A′. Camera units 110 may be attached to a horizontal mounting bar 170 affixed to a surface beneath the knitting machine. The camera units 110 may be oriented toward the surface of a produced tubular fabric 135 that is fed to a storage roll 180. The imaging unit may further comprise multiple light sources 120 that are located so as not to obstruct the field of vision of the camera units 110. The light sources 120 may be located on the same side as the cameras 110 and/or on the opposite side of the tubular fabric 135 to enable different modes of defect detection.

### Example 3—Optical Detection System Configurations

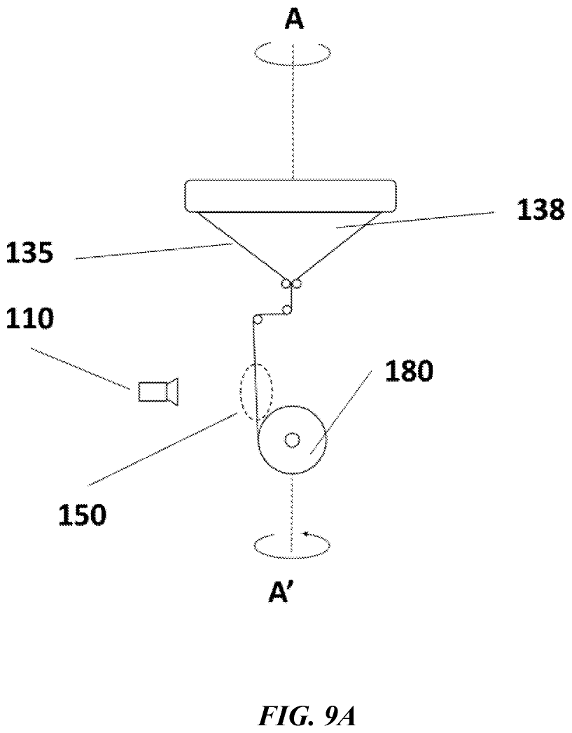

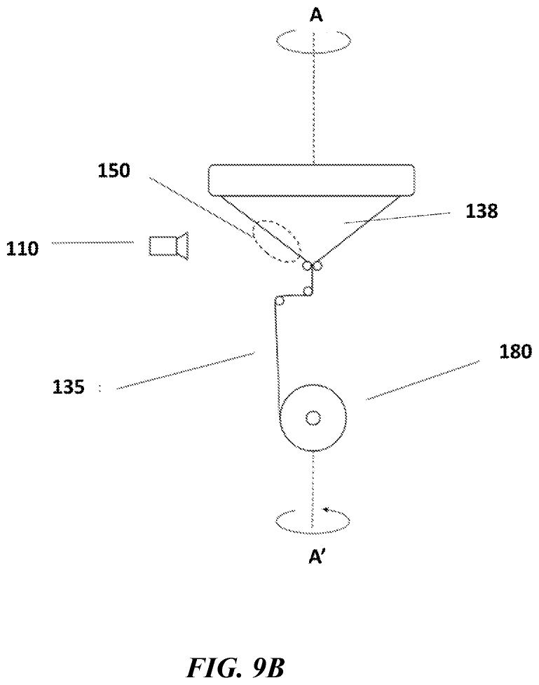

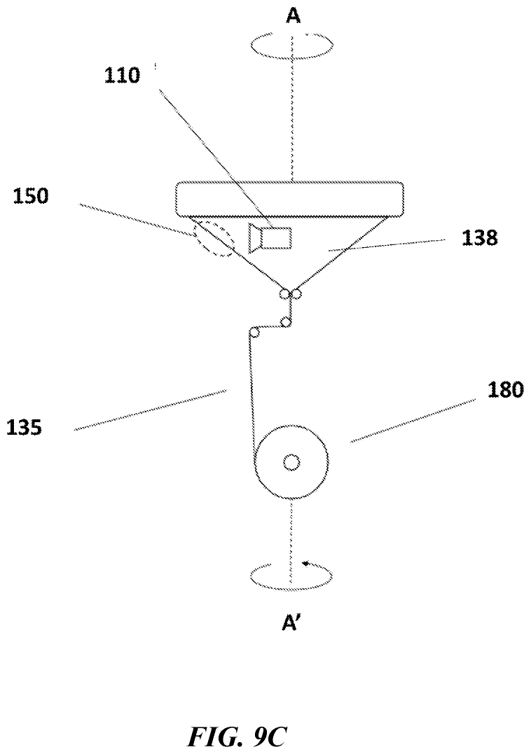

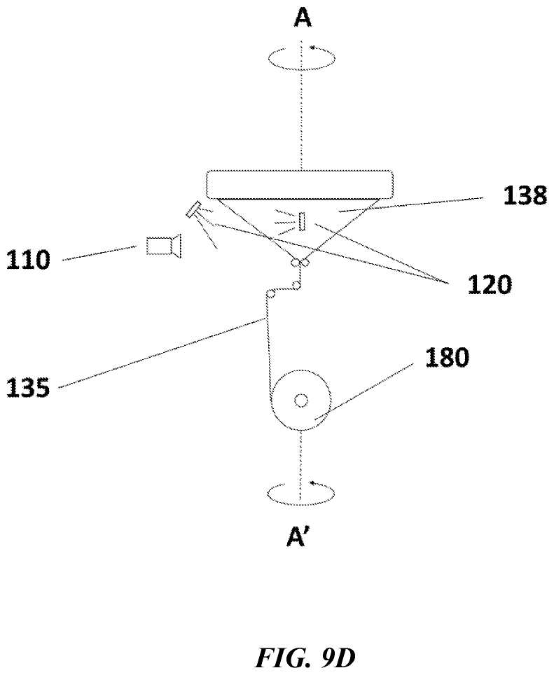

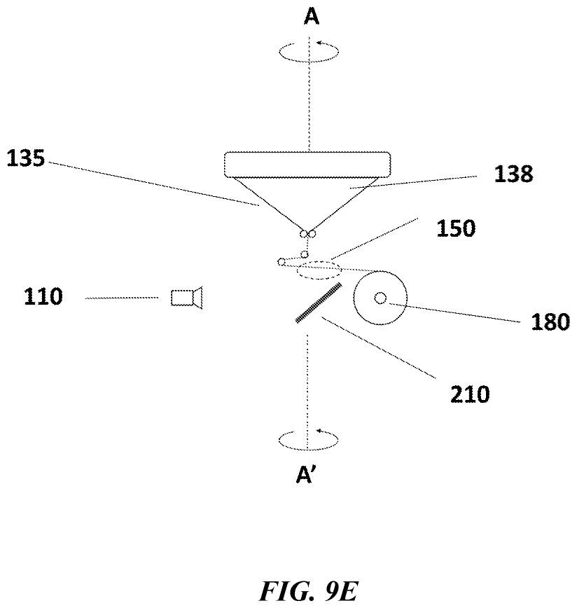

FIGS. 9A-9E depict schematic views of various configurations for imaging units in a rotating circular knitting machine. FIG. 9A shows a camera unit 110 positioned to image a target region 150 near where a tubular fabric material 135 is fed onto a storage roll 180. The camera unit 110 may be located in a stationary or fixed position, or may be mounted to a rotating component that revolves with the rest of the unit about axis A-A′. FIG. 9B shows a similar configuration to FIG. 9B, but the camera unit 110 has been raised to image a target region 150 closer to the knitting region of the knitting machine. In the example of FIG. 9B, the camera unit 110 need not be rotating during imaging while the fabrics tube 138 is rotating. FIG. 9C shows an imaging unit configuration where the camera unit 110 has been positioned within the tubular fabric material 135, thereby creating a target region 150 on the opposite side of the fabric 135 as the target region 150 depicted in FIG. 9B. In the example of FIG. 9C, the camera unit 110 need not be rotating during imaging while the fabrics tube 138 is rotating. FIG. 9D depicts a similar imaging unit to that of FIG. 9B but also including two light sources 120. A first light source 120 is located adjacent to the camera unit while a second light source 120 is positioned within the tubular fabric material 135. The light sources 120 and camera unit 110 may be fixed relative to the rotation about axis A-A′ or may rotate synchronously with the knitting machine. FIG. 9E depicts an imaging unit that incorporates a mirror 210 to enable imaging of a target region that lies nearly horizontal relative to the position of the camera unit 110.

### Example 4—Additional Imaging Unit Configurations

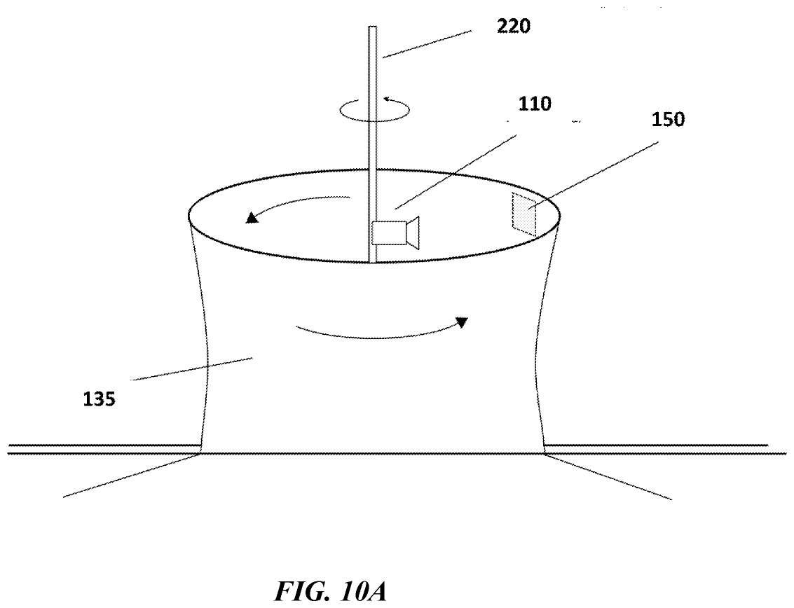

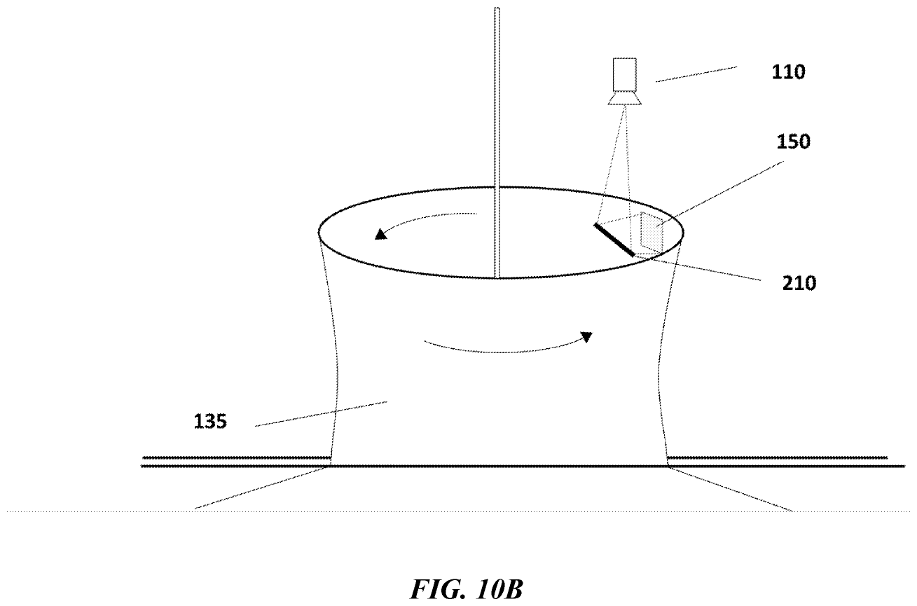

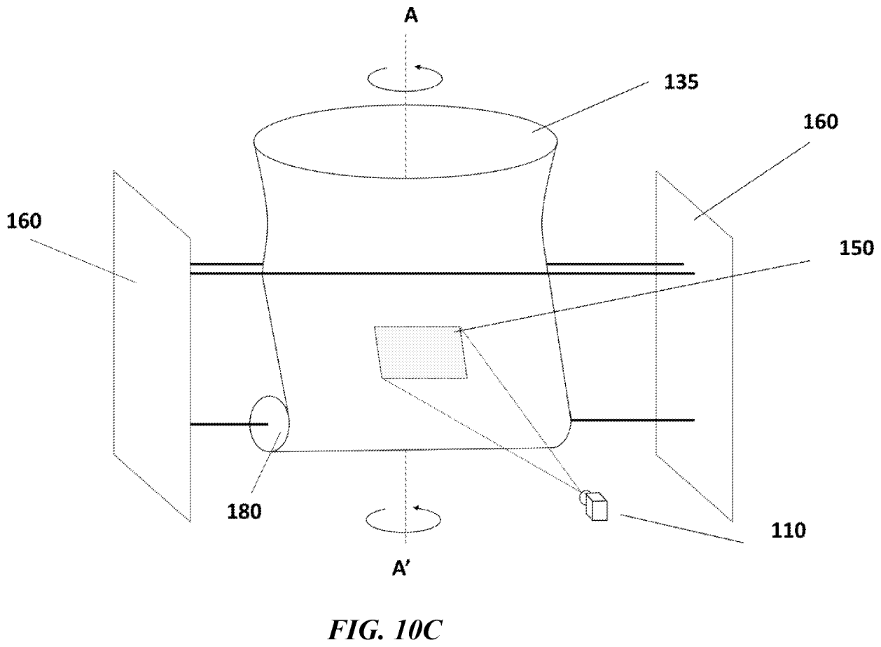

FIGS. 10A-10C depict further configurations of the imaging unit within a circular knitting machine. FIG. 10A depicts a camera unit 110 coupled to a rotating shaft 220 within the knitting region of a circular knitting machine. The camera unit 110 may be coupled such that it has an angular velocity substantially the same as the angular velocity of the rotating shaft 220. In some cases, the camera unit 110 may be coupled such that it has a different angular velocity, e.g., coupled via gearing. The rotation of the camera unit permits imaging of the inner fabric surface by a rotating target region. As the fabric material 135 is produced, the material is pulled downward, exposing new fabric material to the rotating camera 110. FIG. 10B depicts a fixed camera 110 configuration using a mirror 210 to permit imaging of the inner surface of the tubular fabric material 135. The target region 150 in this configuration remains spatially fixed. The entire fabric circumference can be imaged by the addition of more cameras 110 and mirrors 210 (not shown). FIG. 10C depicts an imaging unit configuration where a camera 110 is fixed relative to a rotating knitting machine adjacent to where the flattened fabric material 135 is fed onto the storage roll 180. The target region 150 of the camera 110 remains stationary in this configuration while the knitting machine revolves. This periodically exposes both sides of the fabric to the camera unit 110 when the image is not obstructed by the lateral supports 160.

### Example 5—Optical Detection System

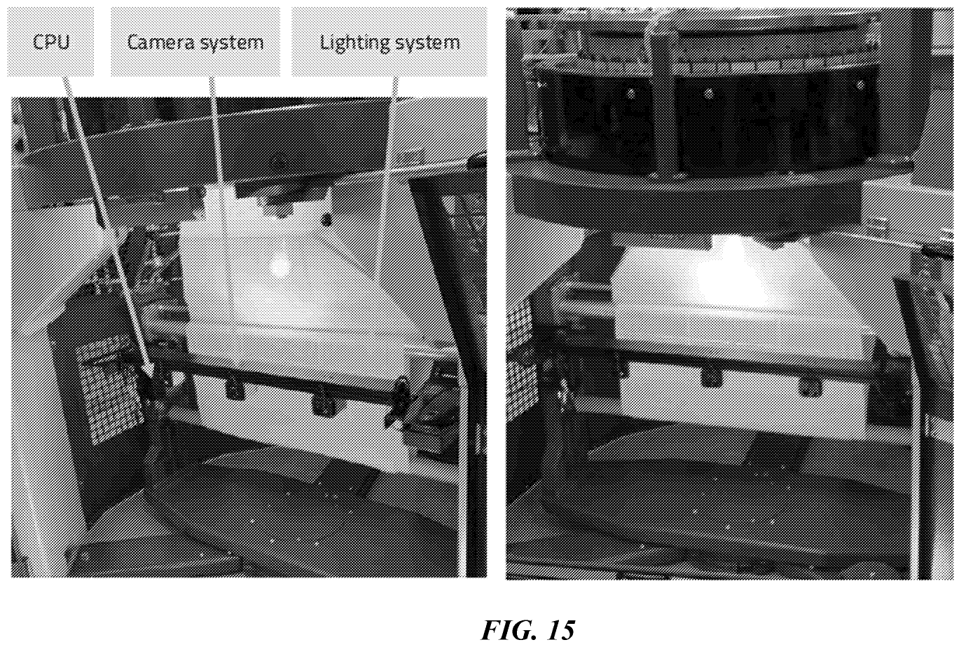

FIG. 15 shows an image of an installed optical detection system for a circular knitting machine. The system features multiple cameras positioned adjacent to a nearly vertical region of flattened fabric material. The cameras are mounted to a horizontal support bar that also contains a visible light source that outputs primarily in the blue and indigo region of the visible spectrum. The imaging unit is directly wired to a central processing unit of the computer system.

### Example 6—Defect Detection Analysis

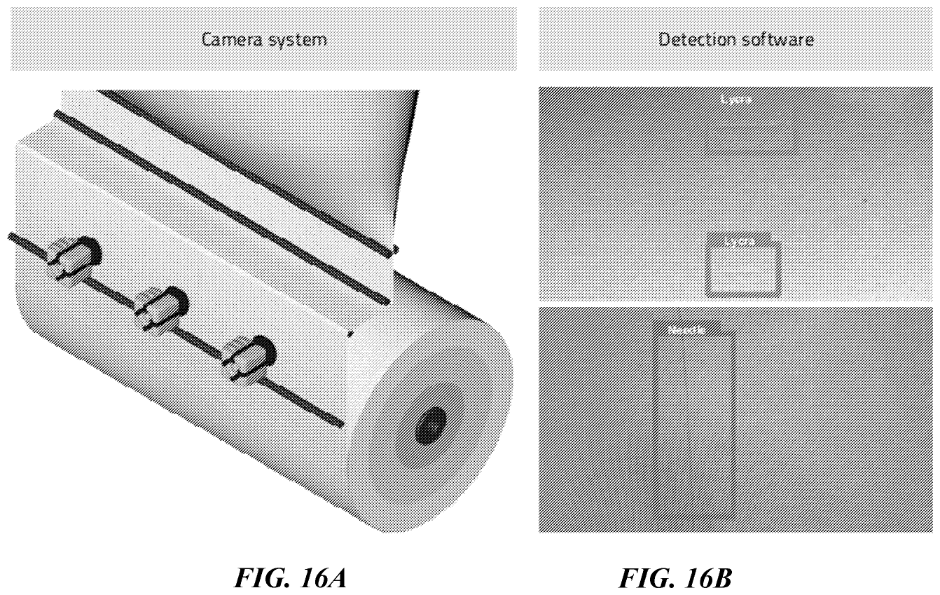

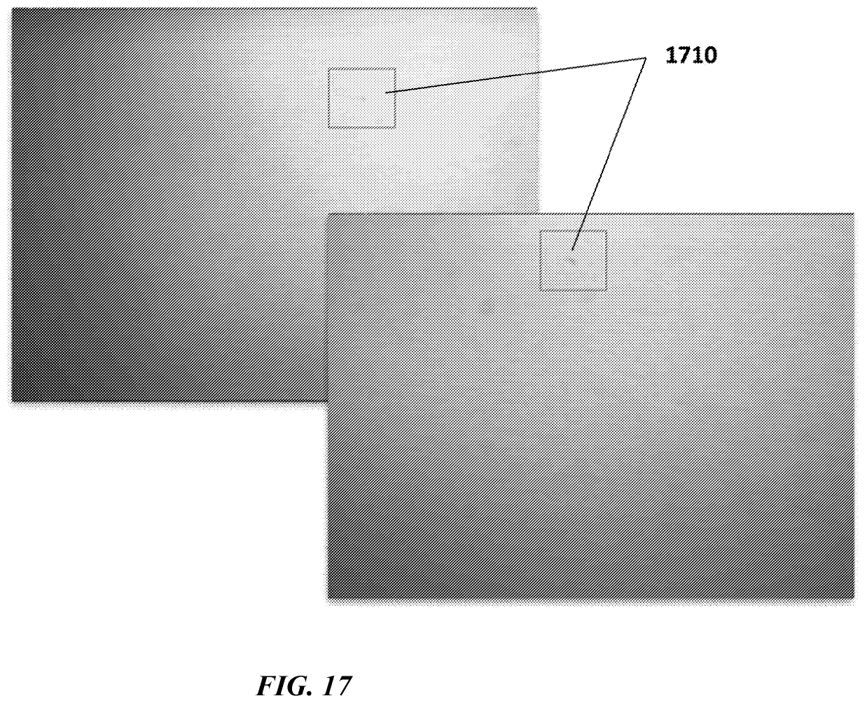

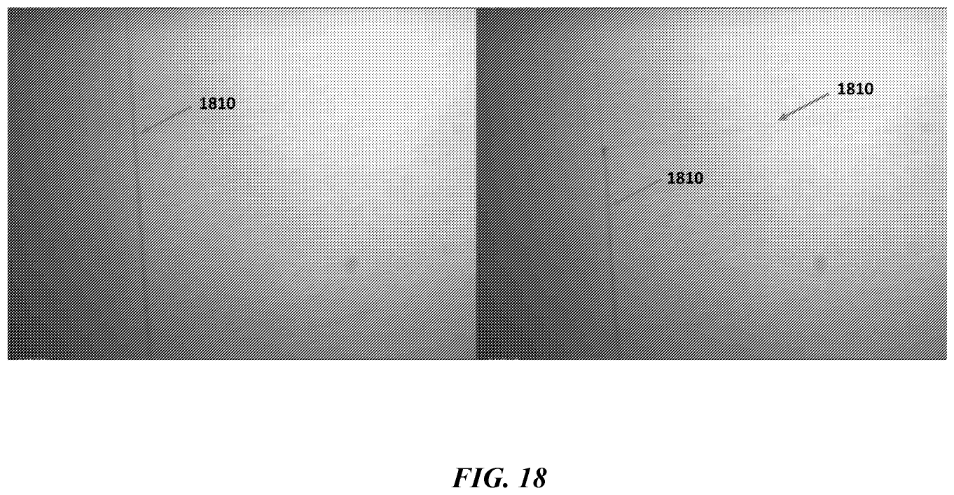

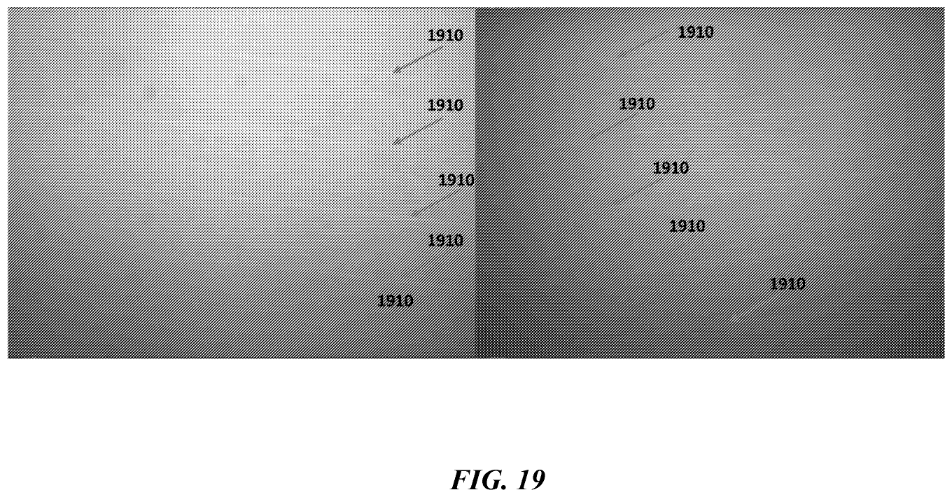

FIG. 16A depicts an exemplary imaging unit for detecting defects in a knitted fabric material. FIG. 16B displays image data collected by an imaging unit capturing suspected defects in a fabric material. The upper image of FIG. 16B depicts a suspected lycra defect in the fabric material. The lower image of FIG. 16B depicts a suspected needle defect in the fabric material. FIG. 17 depicts two overlayed images captured by an imaging unit that was coupled to an indigo light source. The rectangular boxes highlight areas with suspected repeating defects 1710 based upon analysis by an imaging software package. The detection of these repeating defects 1710 by the imaging software prompted a stoppage of the knitting machine, thereby preventing the fabrication of more defective fabric. FIG. 18 depicts two images captured by an imaging unit that was coupled to an indigo light source. The arrows highlight areas with suspected needle defects 1810 based upon analysis by an imaging software package. The detection of these defects 1810 by the imaging software prompted a stoppage of the knitting machine, thereby preventing the fabrication of more defective fabric. FIG. 19 depicts two images captured by an imaging unit that was coupled to an indigo light source. The arrows highlight areas with suspected lycra defects 1910 based upon analysis by an imaging software package. The detection of these defects 1910 by the imaging software prompted a stoppage of the knitting machine, thereby preventing the fabrication of more defective fabric.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A system for monitoring a manufacturing process, said system comprising:
an imaging unit configured for use with a material fabrication machine that is useable to produce a material sheet, wherein said imaging unit is calibrated to a target region of said material sheet, and wherein said imaging unit is configured to (i) capture an image or video corresponding to said target region as said material sheet is produced by said material fabrication machine and (ii) generate data corresponding to said image or video; and
an image analysis unit in communication with said imaging unit, wherein said image analysis unit comprises one or more computer processors that are individually or collectively configured to process said data to control quality or detect a presence of one or more defects on said material sheet substantially in real-time as said material sheet is being produced by said material fabrication machine.

2. The system of claim 1, wherein said material sheet is selected from the group consisting of textile, metal, metal alloy, paper, and plastic.

3. The system of claim 1, further comprising said material fabrication machine, wherein said material fabrication machine comprises a knitting machine or a weaving machine.

4. The system of claim 3, wherein said knitting machine is a circular knitting machine.

5. The system of claim 1, further comprising:
an illumination unit configured to transmit and direct light onto said target region, wherein said light is useable to illuminate a plurality of portions of said material sheet as said plurality of portions passes through said target region during production of said material sheet.

6. The system of claim 5, further comprising a support structure configured to support at least one of (i) said imaging unit and (ii) said illumination unit.

7. The system of claim 6, wherein said support structure is configured to releasably mount to said material fabrication machine.

8. The system of claim 6, wherein said support structure is configured to be a stand-alone structure that is decoupled from said material fabrication machine.

9. The system of claim 5, wherein said light comprises one or more beams having one or more wavelengths from about 10 nanometers to about 1200 nanometers.

10. The system of claim 5, wherein said illumination unit is configured to direct said light at one or more angles relative to a plane defined by said target region.

11. The system of claim 10, wherein said one or more angles ranges from about 1 degree to about 90 degrees.

12. The system of claim 10, wherein at least one of said one or more angles is less than about 1 degree.

13. The system of claim 10, wherein at least one of said one or more angles is greater than about 90 degrees.

14. The system of claim 3, wherein said material fabrication machine comprises at least one rotatable portion that is configured to rotate as said material sheet is produced.

15. The system of claim 14, wherein said at least one rotatable portion comprises a rotative shaft or a rotative frame.

16. The system of claim 15, wherein at least one of (i) said illumination unit and (ii) said imaging unit is configured to be mounted to said rotative shaft or said rotative frame.

17. The system of claim 14, wherein at least one of (i) said illumination unit and (ii) said imaging unit is configured to remain stationary as said at least one rotatable portion is rotating.

18. The system of claim 14, wherein said illumination unit and said imaging unit are configured to remain stationary as said at least one rotatable portion is rotating to produce said material sheet.

19. The system of claim 14, wherein at least one of (i) said illumination unit and (ii) said imaging unit is configured to move relative to said at least one rotatable portion as said at least one rotatable portion is rotating.

20. The system of claim 19, wherein at least one of (i) said illumination unit and (ii) said imaging unit is configured to move at substantially a same speed or in a same direction as said at least one rotatable portion.

21. The system of claim 19, wherein at least one of (i) said illumination unit and (ii) said imaging unit is configured to move at a different speed or in a different direction than said at least one rotatable portion.

22. The system of claim 1, wherein said image analysis unit is further configured to determine a type, shape, or size of said one or more defects.

23. The system of claim 1, further comprising: a controller in communication with said material fabrication machine, wherein said controller is configured to generate a set of instructions for stopping or pausing operation of said material fabrication machine when said image analysis unit detects said presence of said one or more defects on said material sheet.

24. The system of claim 23, wherein said controller is configured to generate a set of corrective action for addressing said one or more defects when said image analysis unit detects said presence of said one or more defects on said material sheet.
